(19) United States
(12) Patent Application Publication
(10) Pub. No.: US 2024/0105917 A1
(43) Pub. Date: Mar. 28, 2024

(54) ACTIVE MATERIAL, ELECTRODE, SECONDARY BATTERY, BATTERY PACK, AND VEHICLE

(71) Applicant: KABUSHIKI KAISHA TOSHIBA, Tokyo (JP)

(72) Inventors: Yasuhiro HARADA, Isehara (JP); Taro FUKAYA, Tokyo (JP); Yasunobu YAMASHITA, Tokyo (JP); Kakuya UEDA, Kawasaki (JP); Yoshiaki MURATA, Kawasaki (JP); Norio TAKAMI, Yokohama (JP)

(73) Assignee: KABUSHIKI KAISHA TOSHIBA, Tokyo (JP)

(21) Appl. No.: 18/174,909

(22) Filed: Feb. 27, 2023

(30) Foreign Application Priority Data
Sep. 15, 2022 (JP) 2022-147326

(51) Int. Cl. H01M 4/36; C01G 33/00; H01M 4/131; H01M 4/133; H01M 4/485; H01M 4/587; H01M 50/574

(52) U.S. Cl. CPC H01M 4/366; C01G 33/006; H01M 4/131; H01M 4/133; H01M 4/485; H01M 4/587; H01M 50/574; H01M 2004/027

(57) ABSTRACT

According to one embodiment, provided is an active material including a niobium titanium-containing oxide phase and a carbon coating layer. The niobium titanium-containing oxide phase contains a niobium titanium-containing oxide having a monoclinic structure and Na, and a Na content therein is 0 ppm or more and 100 ppm or less. The carbon coating layer coats at least a part of the niobium titanium-containing oxide phase, and contains 0.001% or more of carboxyl group.

### CROSS-REFERENCE TO RELATED APPLICATION

This application is based upon and claims the benefit of priority from prior Japanese Patent Application No. 2022-147326 filed Sep. 15, 2022, the entire contents of which are incorporated herein by reference.

### FIELD

Embodiments described herein relate generally to an active material, an electrode, a secondary battery, a battery pack, and a vehicle.

### BACKGROUND

Recently, secondary batteries, such as a nonaqueous electrolyte secondary battery like a lithium ion secondary battery, have been actively researched and developed as a high energy-density battery. The secondary batteries, such as a nonaqueous electrolyte secondary battery, are anticipated as a power source for vehicles such as hybrid electric automobiles, electric automobiles, an uninterruptible power supply for base stations for portable telephones, or the like. Therefore, the secondary battery is demanded to, in addition to having a high energy density, be excellent in other performances such as rapid charge-discharge performances and long-term reliability, as well. For example, not only is the charging time remarkably shortened in a secondary battery capable of rapid charge and discharge, but the battery is also capable of improving motive performances in vehicles such as hybrid electric automobiles, and efficient recovery of regenerative energy of motive force.

In order to enable rapid charge/discharge, electrons and lithium ions must be able to migrate rapidly between the positive electrode and the negative electrode. However, when a battery using a carbon-based negative electrode is repeatedly subjected to rapid charge and discharge, precipitation of dendrite of metallic lithium on the electrode may sometimes occur, raising concern of heat generation or ignition due to internal short circuits.

In light of this, a battery using a metal composite oxide in a negative electrode in place of a carbonaceous material has been developed. In particular, in a battery using an oxide of titanium in the negative electrode, rapid charge and discharge can be stably performed. Such a battery also has a longer life than in the case of using a carbon-based negative electrode.

However, compared to carbonaceous materials, oxides of titanium have a higher potential relative to metallic lithium. That is, oxides of titanium are more noble. Furthermore, oxides of titanium have a lower capacity per weight. Therefore, a battery using an oxide of titanium for the negative electrode has a problem that the energy density is low.

For example, an electrode potential of an oxide of titanium is about 1.5 V (vs. Li/Li⁺) with respect to metallic lithium electrode, which is higher (more noble) compared to potentials of a carbon-based negative electrodes. The potential of an oxide of titanium is electrochemically restricted due to being caused by oxidation-reduction reactions between Ti³⁺ and Ti⁴⁺ upon insertion and extraction of lithium. In addition, there is also a fact that rapid charge and discharge of lithium ions can be stably performed at a high electrode potential of about 1.5 V (vs. Li/Li⁺). Therefore, it has been conventionally difficult to reduce the electrode potential in order to improve the energy density.

On one hand, considering the capacity per unit weight, the theoretical capacity of titanium dioxide (anatase structure) is about 165 mAh/g, and the theoretical capacity of spinel lithium-titanium oxides such as Li₄Ti₅O₁₂ is about 180 mAh/g. On the other hand, the theoretical capacity of a general graphite based electrode material is 385 mAh/g and greater. As such, the capacity density of an oxide of titanium is significantly lower than that of the carbon based negative electrode material. This is due to there being few lithium-insertion sites in the crystal structure, and lithium tending to be stabilized in the structure, and thus, substantial capacity being reduced.

In view of the above circumstances, a new electrode material containing Ti and Nb has been studied. Such a niobium-titanium oxide material is expected to have a high charge/discharge capacity. In particular, an oxide represented by TiNb₂O₇ has a high theoretical capacity exceeding 380 mAh/g. Therefore, the niobium-titanium oxide is anticipated as a high-capacity material in place of Li₄Ti₅Oi₂; however, the niobium-titanium oxide has low electronic conductivity and making electrically conductive channels therein is difficult.

### BRIEF DESCRIPTION OF THE DRAWINGS

FIG. 1 is a cross-sectional view schematically showing an example of a secondary battery according to an embodiment.

FIG. 2 is an enlarged cross-sectional view of section A of the secondary battery shown in FIG. 1.

FIG. 3 is a partially cut-out perspective view schematically showing another example of the secondary battery according to an embodiment.

FIG. 4 is an enlarged cross-sectional view of section B of the secondary battery shown in FIG. 3.

FIG. 5 is a perspective view schematically showing an example of a battery module according to an embodiment.

FIG. 6 is an exploded perspective view schematically showing an example of a battery pack according to an embodiment.

FIG. 7 is a block diagram showing an example of an electric circuit of the battery pack shown in FIG. 6.

FIG. 8 is a partially see-through diagram schematically showing an example of a vehicle according to an embodiment.

FIG. 9 is a diagram schematically showing an example of a control system related to an electric system in the vehicle according to an embodiment.

### DETAILED DESCRIPTION

According to one embodiment, provided is an active material including a niobium titanium-containing oxide phase and a carbon coating layer. The niobium titanium-containing oxide phase contains a niobium titanium-containing oxide having a monoclinic structure and Na, and a Na content therein is 0 ppm or more and 100 ppm or less. The carbon coating layer coats at least a part of the niobium titanium-containing oxide phase, and contains 0.001% or more of carboxyl group.

According to another embodiment, provided is an electrode including the active material according to the above embodiment.

According to still another embodiment, provided is a secondary battery including a positive electrode, a negative electrode, and an electrolyte is provided. The negative electrode includes the electrode according to the above embodiment.

According to yet another embodiment, provided is a battery pack including secondary battery(s). The secondary battery(s) of the battery pack include the secondary battery according to the above embodiment.

According to still yet another embodiment, provided is a vehicle including the battery pack according to the above embodiment.

Hereinafter, embodiments will be described with reference to the drawings. The same reference signs are applied to common components throughout the embodiments and overlapped explanations are thereby omitted. Each drawing is a schematic view for encouraging explanations of the embodiment and understanding thereof, and thus there are some details in which a shape, a size and a ratio are different from those in an actual device; they can however be appropriately design-changed, taking into account the following explanations and known technology. In addition, similar effects can be achieved, even if the compositional elements include inevitable impurities accompanying industrial materials or industrial processes.

### First Embodiment

According to a first embodiment, provided is an active material including a niobium titanium-containing oxide phase and a carbon coating layer containing carboxyl groups. The niobium titanium-containing oxide phase has a monoclinic structure. An Na (sodium) content in the niobium titanium-containing oxide phase is 0 ppm or more and 100 ppm or less in mass proportions. The carbon coating layer that contains carboxyl groups coats at least a part of the niobium titanium-containing oxide phase. The carbon coating layer contains 0.001% or more of the carboxyl groups.

In one aspect, the monoclinic niobium titanium-containing oxide phase contains one or more crystal structures that belong to Nb₂TiO₇ phase type crystal structure, Nb₁₀Ti₂O₂₉ phase type crystal structure, Nb₁₄TiO₃₇ phase type crystal structure, or Nb₂₄TiO₆₂ phase type crystal structure. In other words, the niobium titanium-containing oxide phase contains a crystal structure having at least one phase selected from the group consisting of Nb₂TiO₇ phase, Nb₁₀Ti₂O₂₉ phase, Nb₁₄TiO₃₇ phase, and Nb₂₄TiO₆₄ phase. Any of these phases may contain at least one selected from the group consisting of K, Zr, Sn, V, Nb, Ta, Mo, W, Y, Fe, Co, Cr, Mn, Ni, and Al.

In another aspect, among the monoclinic niobium titanium-containing oxide phases described above, the Nb₂TiO₇ phase may be represented by general formula Nb₂M1_{z}Ti_{1-z}O₇. Here, M1 includes at least one selected from the group consisting of K, Zr, Sn, V, Nb, Ta, Mo, W, Y, Fe, Co, Cr, Mn, Ni, and Al. The subscript z falls within a range of 0<z<1. The composition in the case where Li is inserted into Nb₂TiO₇ phase may be represented by LiₐNb₂M1_{z}Ti_{1-z}O₇. Here, the subscript z is as described above, and the subscript a falls within a range of 0≤a≤5.

The composition of the Nb₁₀Ti₂O₂₉ phase can be represented by, for example, general formula Nb₁₀₋ₓM1ₓTi_{2-y}M₂yO₂₉. Here, M1 is same as that for the Nb₂TiO₇ phase. The subscript x falls within a range of 0≤x≤5, and the subscript y falls within a range of 0≤y≤1. The composition in the case where Li is inserted into Nb₁₀Ti₂O₂₉ phase may be represented by Li_{b}Nb₁₀₋ₓM1ₓTi_{2-y}M2_{y}O₂₉. Here, the subscripts x and y are as described above, and the subscript b falls within a range of 0≤b≤22.

The composition of the Nb₁₄TiO₃₇ phase can be represented by, for example, general formula Nb₁₄₋ₓM1ₓTi_{1-y}M2_{y}O₃₇. Here, M1, subscript x, and subscript y are same as those for the Nb₁₀Ti₂O₂₉ phase. M2 is one or more among the same elements as M1. M1 and M2 may be same, or M1 and M2 may be different. The composition in the case where Li is inserted into the Nb₁₄TiO₃₇ phase may be represented by Li_{c}Nb₁₄₋ₓM1ₓTi_{1-y}M2_{y}O₃₇. Here, subscripts x and y are as described above, and the subscript c falls within a range of 0≤c≤29.

The composition of the Nb₂₄TiO₆₂ phase can be represented by, for example, general formula Nb₂₄₋ₓM1ₓTi_{1-y}M2_{y}O₆₂. Here, M1, M2, subscript x, and subscript y are the same as those for the Nb₁₄TiO₃₇ phase. The composition in the case where Li is inserted into the Nb₂₄TiO₆₂ phase may be represented by Li_{d}Nb₂₄₋ₓM1ₓTi_{1-y}M2_{y}O₆₂. Here, the subscripts x and y are as described above, and the subscript d falls within a range of 0≤d≤49.

In either of the aspects, the active material may be a battery active material. If the active material is a battery active material, the active material may be contained in an electrode. In the electrode, the active material may be contained in an active material-containing layer. The active material-containing layer may further contain an electro-conductive agent and a binder. The electrode containing the active material may be included as, for example, a negative electrode in a secondary battery. The secondary battery may be a lithium secondary battery. If the active material is contained in the lithium secondary battery, lithium may be inserted into and extracted from the active material.

When using the monoclinic niobium titanium-containing oxide as the active material for a battery, there has been a problem in that, since electronic conductivity within the active material-containing layer is insufficient, the electron conduction network becomes severed due to volume change during charging and discharging, thereby promoting capacity degradation. While use of a fibrous carbon, a representative thereof being carbon nanotube, improves electrical conductivity, the cost thereof is high, posing a practical problem. A catalytic metal such as Co, Mn or Fe that functions as a growth nucleus is used in production of fibrous carbon. The catalytic metal is difficult to remove after growth of the fibrous carbon, which leads to higher cost. Hence, low-cost fibrous carbon typically contains Co, Mn or Fe as a residual catalytic metal that remains unremoved and abundant. Such metal residue has been known to elute into the electrolyte solution due to electrochemical reaction.

Moreover, elution of Mn and Co also occurs from a nickel manganese cobalt-based positive electrode, for example. Hence, at a potential such as the redox potential of the monoclinic niobium titanium oxide, which is lower than the redox potential of lithium titanium oxide but higher than the charge potential of carbonaceous negative electrode, the metal ion eluted into the electrolyte reductively deposits over time onto the electrode composed of the monoclinic niobium titanium oxide. Hence, a battery using the monoclinic niobium titanium oxide as a negative electrode active material has suffered from a problem in that the self-discharge would increase due to the reductive deposition of the eluted metal onto the negative electrode, whereby the storage performance degrades.

The active material according to the first embodiment includes a monoclinic niobium titanium-containing oxide phase, and a carbon coating layer containing carboxyl groups. The carbon coating layer containing the carboxyl groups coats at least a part of the surface of the monoclinic niobium titanium-containing oxide phase. This provides an effect where the carboxyl groups adsorb metal ions such as Co cations and Mn cations that approach the surface of the monoclinic niobium titanium-containing oxide.

When a very small amount of sodium is contained in the monoclinic niobium titanium-containing oxide, lithium ion conduction on the surface of the active material is inhibited. As a result, an overvoltage accelerates the reductive deposition reaction. In addition, adsorption of sodium ions onto the carboxyl groups reduces the capability of adsorbing metal ions. Thus, the amount of sodium contained in the niobium titanium-containing oxide phase is preferably little. For this reason, a monoclinic niobium titanium-containing oxide with a Na content of 100 ppm or less is used for the active material.

By having the carbon coating layer containing carboxyl groups coated on at least a part of the surface of the monoclinic niobium titanium-containing oxide phase with a Na content of 100 ppm or less, in such a manner, use of an inexpensive fibrous carbon containing catalyst residue becomes possible, and on top of that, metal ions eluted from a nickel cobalt manganese-based oxide and the like can be adsorbed. Thereby, the same level of electronic conductivity can be secured as with conventional carbon coatings, and on top of that, the acceleration of the self-discharge due to metal elution, which has been a problem, can be suppressed, thereby improving the storage performance. The lower limit of the Na content is preferably 10 ppm or greater, and more preferably 40 ppm or greater. Meanwhile, the upper limit of the Na content is preferably 80 ppm or less, and more preferably 60 ppm or less.

<Particle Size>

In an aspect as an electrode material, the active material may include plural active material particles each containing the niobium titanium-containing oxide phase and the carbon coating layer. For the active material particles included in the electrode material, in a particle size distribution chart obtained by a laser diffraction scattering method, a particle size D₁₀, at which the volume cumulative frequency from the smaller side of particle size reaches 10%, is preferably within the range of 0.3 μm to 2.0 μm. With D₁₀ of 0.3 μm or greater, there is a tendency where side reactions between the active material and the electrolyte are suppressed, thereby improving the charge-discharge efficiency and the cycle life performance. When D₁₀ is 2.0 μm or less, the rapid charge-discharge performance tends to be higher. D₁₀ more preferably falls within the range of 0.5 μm to 1.0 μm.

Meanwhile, a particle size D₉₀, at which the volume cumulative frequency from the smaller side of particle size reaches 90% in the particle size distribution chart, preferably falls within the range of 5 μm to 30 μm. With D₉₀ of 5 μm or greater, for an electrode using the electrode material, there is a tendency where the active material-containing layer becomes less likely to separate from a current collector, whereby the life performance improves. When D₉₀ is 30 μm or less, the rapid charge-discharge performance tends to be higher. D₉₀ more preferably falls within the range of 6 μm to 10 μm.

A large value of D₁₀ indicates scarcity of fine powder, while a small value of D₉₀ indicates scarcity of coarse particles. That is, they mean that the main peak in the particle size distribution tends to be sharp. Although a sharp main peak is not always preferred, whether the particle size distribution contains a sharp peak or not may be evaluated based on values of a ratio of D₁₀ relative to particle size D₅₀ at which the volume cumulative frequency from the smaller side of particle size reaches 50%, and a ratio of D₉₀ relative to D₅₀.

Preferably, the ratio D₁₀/D₅₀ falls within the range of 0.1 to 0.6 while the ratio D₅₀/D₉₀ falls within the range of 0.2 to 0.5. With both ranges fulfilled, small sized active material particles can disperse into gaps among large sized active material particles, whereby the diffusion distance of carrier ions among the active material particles, for example, the migration distance of lithium ions within the electrolyte, can be made short. Thereby, while enhancing rapid-charge/discharge performance, excellent life performance can also be attained. With the ratio D₁₀/D₅₀ adjusted to 0.1 or greater while having the ratio D₅₀/D₉₀ adjusted to 0.2 or greater, the particles tend to have less bias in particle size, facilitating increase of electrode density. More preferably, the ratio D₁₀/D₅₀ falls within the range of 0.15 to 0.30 with the ratio D₅₀/D₉₀ falling within the range of 0.20 to 0.40. With the ratio D₁₀/D₅₀ adjusted to 0.60 or smaller while having the proportion D₅₀/D₉₀ adjusted to 0.50 or smaller, flexibility of the electrode can be maintained. This allows a battery structure having the electrode wound up to be adopted without difficulty.

Although the value of D₅₀ of the active material particles in the embodiment is not particularly restricted, the value maybe, for example, within the range of 0.5 μm to and 30 μm. In other words, the active material may be formed of active material particles having an average primary particle size of 0.5 μm to 30 μm.

The particle size distribution chart may correspond to a histogram for the active material particles included in the electrode material.

The aforementioned active material particle may be a secondary particle formed of primary particles. The particle size of the secondary particles in this case is not particularly limited.

<BET Specific Surface Area>

Considering the active material as being, for example, an active material particle in which the niobium titanium-containing oxide phase takes a particulate form, where the surface of such a niobium titanium-containing oxide particle is covered with the carboxyl group-containing carbon coating layer, the BET specific surface area of the active material particle is preferably 0.8 m²/g or larger and smaller than 50 m²/g. The BET specific surface area of the active material particle is more preferably 2 m²/g to 5 m²/g.

When the BET specific surface area is 0.8 m²/g or more, the contact area between the active material particle and electrolyte can be secured. Thus, good discharge rate performances can be easily obtained and also, a charge time can be shortened. On the other hand, when the BET specific surface area is less than 50 m²/g, reactivity between the active material and electrolyte can be kept from being too high and therefore, whereby the life performance can be improved. When the BET specific surface area is 5 m²/g or less, side reactions with the electrolyte can be suppressed, and thereby longer life can be further expected. Furthermore, in this case, an applicability can be improved for a slurry including the active material used in a later-described production of an electrode.

Here, for the measurement of the specific surface area, a method is used where molecules, for which an occupied area in adsorption is known, are adsorbed onto the surface of powder particles at the temperature of liquid nitrogen, and the specific surface area of the sample is determined from the amount of adsorbed molecules. The most often used method is a BET method based on the low temperature/low humidity physical adsorption of an inert gas. This BET method is a method based on the BET theory, which is the most well-known theory of the method of calculating the specific surface area in which the Langmuir theory, which is a monolayer adsorption theory, is extended to multilayer adsorption. The specific surface area determined by the above method is referred to as “BET specific surface area”.

The above-described effect can be obtained when the carbon coating layer containing carboxyl groups is present on at least a part of the surface of the niobium titanium-containing oxide phase. For example, the carbon-coat weight ratio by the carbon coating layer on the oxide phase is preferably 0.5 wt % or more. The carbon-coat weight ratio of the carbon coating layer on the oxide phase can be obtained by a measurement result obtained by a method described later.

The thickness of the carbon coating layer is not particularly limited, and is preferably with the range of 0.5 nm to 30 nm. If the thickness is less than 0.5 nm, the coverage by the carbon coating layer is small, and the effect can hardly be obtained. On the other hand, if the thickness is more than 30 nm, the movement of Li ions is undesirably impeded.

The amount of carboxyl group contained in the carbon coating layer is represented by the carboxyl group concentration (molecular concentration) in the carbon coating layer, which is determined by a method described later. In the active material, the carboxyl group content in the carbon coating layer is an amount at which the carboxyl group concentration would be 0.001% or higher. With the carboxyl group concentration being 0.001% or higher, the effect of adsorbing and capturing Na ions and eluted metal ions derived from the positive electrode in the electrolyte may be suitably demonstrated.

<Production Method>

The active material according to the first embodiment can be produced by a synthesis method described below.

The niobium titanium-containing oxide having a monoclinic structure may be synthesized as follows. First, the starting materials are mixed. Oxides or salts that contain niobium and titanium are prepared as starting materials containing Nb and Ti. Oxides or salts that contain at least one element selected from the group consisting of K, Zr, Sn, V, Nb, Ta, Mo, W, Y, Fe, Co, Cr, Mn, Ni, and Al are prepared as starting materials that contain element M1 and M2. The salts used as the starting material are preferably those that decompose at relatively low temperatures to produce oxides, such as carbonates or nitrates.

These starting materials are mixed at a molar ratio suited for a target composition. The obtained mixture is then milled to obtain a mixture which is uniform as possible. The obtained mixture is then subjected to preliminary firing (first firing). The preliminary firing (first firing) is conducted in a temperature range of 500° C. to 900° C., divided into twice or more times for a total of 10 hours to 40 hours. Thereby, precursor particles with high uniformity can be obtained.

The obtained precursor particles are then subjected to wet mixing. The wet mixing at this time is conducted with use of a solvent capable of dissolving the sodium component such as ion-exchanged water, and thereafter, the mixed solvent is heated to 60° C. The solvent and the precursor particles are then separated by sedimentation, and the precursor particles are placed again in ion-exchanged water, followed by mixing. This removes sodium components from the surface of the precursor particles. As a result of such sodium removal treatment, there can be obtained a niobium titanium-containing oxide phase in which the Na content is reduced to 100 ppm or less, or excluded.

The precursor particles obtained after the wet mixing is then subjected to main firing (second firing). The main firing is preferably conducted at a temperature of 800° C. to 1450° C., over a span of 1 hour to 10 hours. The main firing is preferably conducted at a temperature of 1000° C. to 1450° C., over a span of 2.5 hours to 3.5 hours. The thus obtained powder is then milled. The milling may employ, for example, a roller compactor, a bead mill apparatus, or a ball mill apparatus.

By suitably varying conditions of milling, D₁₀, D₅₀ and D₉₀ can be controlled for the electrode material obtained. For example, extension of the milling time tends to reduce D₁₀, D₅₀, and D₉₀. Again for example, use of a milling medium with smaller diameter tends to reduce D₁₀, D₅₀, and D₉₀. Alternatively, centrifugation of the powder enables collection of the powder having small D₁₀, or collection of the powder having large D₉₀. For example, D₁₀, D₅₀, and D₉₀ may be controlled by mixing the collected particles with an electrode material that has been separately synthesized.

An annealing treatment may be performed after the milling. A temperature of the annealing treatment is desirably 350° C. or higher and 800° C. or lower. The annealing treatment performed in this temperature range can mitigate strain within the crystal, thereby stabilizing the post-milling crystal state.

Next, the surface of the monoclinic niobium titanium-containing oxide obtained by synthesizing in the above manner is covered with a carbon coating layer containing carboxyl group. For example, a polyvinyl acetate resin obtained by polymerizing polyvinyl alcohol vinyl acetate monomer is saponified, dissolved in water, and mixed with the niobium titanium-containing oxide to obtain a mixture. This mixture is granulated and dried using a spray-dry method, for example, thereby obtaining granules.

As the polyvinyl alcohol (PVA), PVA with a saponification degree of from 70% to 98% is preferably used. If PVA with a saponification degree of less than 70% is used, the solubility in water increases. In this case, since there is delay in precipitation of PVA onto the oxide surface when drying the dispersion solvent, the niobium titanium-containing oxide tends to aggregate.

On the other hand, in order for there to have carboxyl groups remaining in the carbon coating layer, the saponification degree is preferably low. However, the solution viscosity tends to be more stable with a higher saponification degree. From the perspective of making the carbon coating layer formed on the oxide surface uniform, the saponification degree is preferably higher. However, PVA whose saponification degree is higher than 98% has remarkably low solubility in water. Therefore, considering productivity, a saponification degree of 98% or less is preferable. A more preferable range of the saponification degree is from 70% to 85%.

The obtained granules are subjected to heat treatment within the range of from 500° C. to 750° C. under a nitrogen atmosphere and carbonized. At this time, in order to have the carboxyl groups remain, the temperature and time of the treatment are adjusted in accordance with the saponification degree of used polyvinyl acetate. If the heat treatment is applied by a conventional method, the carboxyl group is carbonized without remaining. An example of an appropriate heat treatment method will be described below.

First, a sample is heated to 500° C. for 30 min in a nitrogen flow atmosphere using a tube furnace as preheating for dehydration, and then cooled down to room temperature. Next, the sample is transferred into a glass tube. The glass tube is evacuated, and nitrogen is then sealed therein. A carbonization heat treatment is performed at 400° C. to 700° C. in the closed nitrogen atmosphere. The heating is continued until a tar-like viscous liquid adheres to the glass tube (for about 1 hour).

By performing the heat treatment in this way, the carboxyl group can be left remaining at the time of carbonization. The preferable heating temperature differs depending on the saponification degree. Namely, the heat temperature is preferably changed, for example, as indicated in Table 1. An active material containing the oxide (niobium titanium-containing oxide phase) covered with the carboxyl group-containing carbon layer is thus obtained.

TABLE 1

| Saponification | Carbonization conditions |
|---|---|
| degree | Temperature, Time |
| 95 | 500° C., 1 h |
| 80 | 550° C., 1 h |
| 75 | 600° C., 1 h |
| 70 | 700° C., 1 h |

As described above, for example, if the heat treatment is applied based on a conventional carbonization method, the carboxyl group cannot be left remaining. An oxide particle covered with such a carbon coating layer, in which the carboxyl group has been carbonized, can be immersed in a solution containing a compound having a carboxyl group, for example, and thereby, carboxyl groups can be added to the surface of the carbon coating layer. Also in a case in which the composite oxide is immersed in a solution containing a compound having a carboxyl group, for example, the carboxyl group may similarly become added to the surface of the carbon coating layer. When the carboxyl group is added in this way, a structure is obtained where much carboxyl group is distributed on the surface of the carbon coating layer. In this case, while adsorption of metal ions in the electrolyte primarily takes place on the surface of the coating layer, the carboxyl groups on the carbon coating layer surface may inhibit interparticle electronic conductivity.

In contrast, if the carboxyl group is left remaining, for example, by firing of the above-described method, on one hand, the carbonized surface (the surface of the carbon coating layer) is sufficiently exposed to the heat source and carbonization has proceeded, while on the other hand, much carboxyl group remains at the interface between the carbon coating layer and the niobium titanium-containing oxide phase. Thereby, the electronic conductivity at the carbon coating layer surface is high, while metal ions are adsorbed at the interior of the carbon coating layer. Therefore, life performance improvement and suppression of self-discharge can be simultaneously achieved.

<Method of Measuring Active Material>

Next, a method for obtaining an X-ray diffraction diagram of the niobium titanium-containing compound according to a powder X-ray diffraction method, and a method for examining the composition of the niobium titanium-containing oxide will be described. A method of measuring the amount of carbon in the carbon coating layer, the thickness of the carbon layer, and the amount of carboxyl group will also be explained.

When the target active material to be measured is included in an electrode material of a secondary battery, a pre-treatment is performed as described below.

First, a state close to the state in which Li ions are completely extracted from a crystal of the oxide phase in the active material is achieved. For example, when the target active material to be measured is included in a negative electrode, the battery is brought into a completely discharged state. For example, a battery can be discharged in a 25° C. environment at 0.1 C current to a rated end voltage, whereby the discharged state of the battery can be achieved. Although a slight amount of residual lithium ions may be present even in the discharged state, this does not significantly affect results of powder X-ray diffraction measurement described below.

Next, the battery is disassembled in a glove box filled with argon, and the electrode is taken out. The taken-out electrode is washed with an appropriate solvent and dried under reduced pressure. For example, ethyl methyl carbonate may be used for washing. After washing and drying, the surface is examined to make sure there are no white precipitates such as that of lithium salts.

The washed electrode is processed or treated into a measurement sample as appropriate, in accordance with the respective measurement method. For example, in the case of subjecting to the powder X ray diffraction measurement, the washed electrode is cut into a size having the same area as that of a holder of the powder X ray diffraction apparatus, and used as a measurement sample.

When necessary, the active material is extracted from the electrode to be used as a measurement sample. For example, in the case of subjecting to a composition analysis, or in the case of measuring the amount of carbon, the active material is taken out from the washed electrode, and the taken-out active material is analyzed, as described later.

<Method for Obtaining X-Ray Diffraction Diagram of Oxide According to Powder X-Ray Diffraction>

The crystal structure included in the active material can be examined by powder X-Ray Diffraction (XRD). By analyzing the measurement results of powder X-Ray Diffraction, the crystal structure included in the niobium titanium-containing oxide phase that is included in the active material according to the embodiment can be examined, for example.

The powder X-ray diffraction measurement of the active material is performed as follows.

First, the target sample is ground until an average particle size reaches about 5 μm. Even if the original average particle size is less than 5 μm, the sample is preferably subjected to a grinding treatment with a mortar or the like, in order to grind apart aggregates. The average particle size can be obtained by laser diffraction, for example.

The ground sample is filled in a holder part having a depth of 0.5 mm, formed on a glass sample plate. As the glass sample plate, for example, a glass sample plate manufactured by Rigaku Corporation is used. At this time, care should be taken to fill the holder part sufficiently with the sample. Precaution should be taken to avoid cracking and formation of voids caused by insufficient filling of the sample. Then, another glass plate is used to smoothen the surface of the sample by sufficiently pressing the glass plate against the sample. In this case, precaution should be taken to avoid too much or too little a filling amount, so as to prevent any rises and depressions relative to the basic plane of the glass holder.

Next, the glass plate filled with the sample is set in a powder X ray diffractometer, and a diffraction pattern (XRD pattern; X-Ray Diffraction pattern) is obtained using Cu-Kα rays.

When the target active material to be measured is included in the electrode material of a secondary battery, first, a measurement sample is prepared according to the procedure described above. The obtained measurement sample is affixed directly onto the glass holder, and measured.

Upon which, the position of peaks originating from the electrode substrate such as a metal foil is measured in advance. The peaks of other components such as an electro-conductive agent and a binder are also measured in advance. In such a case that the peaks of the substrate and active material overlap with each other, it is desirable that the layer including the active material (e.g., active material-containing layer) is separated from the substrate, and subjected to measurement. This is in order to separate the overlapping peaks when quantitatively measuring the peak intensity. For example, the active material-containing layer can be separated by irradiating the electrode substrate with an ultrasonic wave in a solvent.

In the case where there is high degree of orientation in the sample, there is possibility of deviation of peak position and variation in an intensity ratio, depending on how the sample is filled. For example, in some cases, there may be observed from the results of the later-described Rietveld analysis, an orientation in which crystal planes are arranged in a specific direction when packing the sample, depending on the shapes of particles. Alternatively, in some cases, influence due to orientation can be seen from measuring of a measurement sample that had been obtained by taking out from a battery.

Such a sample having high orientation is measured using a capillary (cylindrical glass narrow tube). Specifically, the sample is inserted into the capillary, which is then mounted on a rotary sample table and measured while being rotated. Such a measuring method can provide the result with the influence of orientation reduced.

When an intensity ratio measured by this method is different from an intensity ratio measured using the flat plate holder or glass holder described above, influence due to orientation is considerable, and therefore measurement results of the rotary sample table are adopted.

As an apparatus for powder X ray diffraction measurement, SmartLab manufactured by Rigaku is used, for example. Measurement is performed under the following conditions:
X ray source: Cu target
Output: 45 kV, 200 mA
soller slit: 5 degrees in both incident light and received light
step width (2θ): 0.02 deg
scan speed: 20 deg/min
semiconductor detector: D/teX Ultra 250
sample plate holder: flat glass sample plate holder (0.5 mm thick)
measurement range: range within 5°≤2θ≤90°

When another apparatus is used, in order to obtain measurement results equivalent to those described above, measurement using a standard Si powder for powder X ray diffraction is performed, and measurement is conducted with conditions adjusted such that peak intensities and peak top positions correspond to those obtained using the above apparatus.

Conditions of the above powder X ray diffraction measurement is set, such that an XRD pattern applicable to Rietveld analysis is obtained. In order to collect data for Rietveld analysis, specifically, the measurement time or X ray intensity is appropriately adjusted in such a manner that the step width is made ⅓ to ⅕ of the minimum half width of the diffraction peaks, and the intensity at the peak position of strongest reflected intensity is 5,000 cps or more. Rietveld analysis can be performed, for example, based on the method described in “Funmatsu X-sen Kaiseki no Jissai (Reality of Powder X-Ray Analysis)”, first edition (2002), X-Ray Analysis Investigation Conversazione, The Japan Society for Analytical Chemistry, written and edited by Izumi Nakai and Fujio Izumi (Asakura Publishing Co., Ltd.).

Using the above-described method, information on the crystal structure of the measured active material can be obtained. For example, when the active material according to the first embodiment is measured as described above, the measured active material would be found to include an oxide having a monoclinic structure. In addition, the above-described measurement also allows examination of the crystallinity or symmetry of the crystal structure in the measurement sample, such as monoclinic system.

<Method for Examining Composition of Niobium Titanium-Containing Oxide>

The composition of the niobium titanium-containing oxide in the active material can be analyzed using Inductively Coupled Plasma (ICP) emission spectrometry, for example. Hereupon, the abundance ratios of elements depend on the sensitivity of the analyzing device used. Therefore, when the composition of the niobium titanium-containing oxide phase included in an example of the active material according to the first embodiment is analyzed using ICP emission spectrometry, for example, the numerical values may deviate from the previously described element ratios due to errors of the measuring device. However, even if the measurement results deviate as described above within the error range of the analyzing device, the example active material can sufficiently exhibit the previously described effects.

In order to measure the composition of the active material assembled into a battery according to ICP emission spectrometry, the following procedure is specifically performed.

First, according to the previously described procedure, an electrode including the target active material to be measured is taken out from the secondary battery, and washed. The washed electrode is put in a suitable solvent, and irradiated with an ultrasonic wave. For example, an electrode is put into ethyl methyl carbonate in a glass beaker, and the glass beaker is vibrated in an ultrasonic washing machine, and thereby active material-containing layer can be separated from the current collector.

Next, the separated active material-containing layer is dried under reduced pressure. The obtained active material-containing layer is ground in a mortar or the like to provide a powder including the target active material, electro-conductive agent, binder, and the like. By dissolving the powder in an acid, a liquid sample including the active material can be prepared. Here, hydrochloric acid, nitric acid, sulfuric acid, hydrogen fluoride, and the like may be used as the acid. The components in the active material, for example, composition of the niobium titanium-containing oxide phase can be found by subjecting the liquid sample to ICP emission spectrometric analysis. The composition of the niobium titanium-containing oxide phase that can be analyzed by the ICP method includes the composition of the niobium titanium-containing oxide of monoclinic structure, Na content in the phase, and the like.

<Method of Measuring Carbon Amount>

The amount of carbon in the active material can be measured by using as the measurement sample, for example, the active material extracted from an electrode as follows. First, the electrode, which has been washed as described above, is placed in water, and thereby the active material-containing layer is quenched in water. The active material can be extracted from the quenched electrode using, for example, a centrifugation apparatus. For example, when polyvinylidene fluoride (PVdF) is used as a binder, the extraction treatment is performed by removing the binder component by washing with N-methyl-2-pyrrolidone (NMP) or the like, and then removing the electro-conductive agent using a mesh having an adequate aperture. If these components slightly remain, they can be removed by heat treatment in the air (e.g., for 30 minutes at 250° C.). The active material extracted from the electrode is dried at 150° C. for 12 hours, weighed out in a container, and measured using a measuring device (e.g., CS-444LS manufactured by LECO).

There may be a case where other active materials are included in the electrode, in which case, measurement can be performed as follows.

The active material extracted from the electrode is subjected to measurement by transmission electron microscopy-energy dispersive x-ray spectroscopy (TEM-EDX), and the crystal structure of each particle is identified using the selected area diffraction method. The particles having a diffraction pattern assigned to monoclinic niobium titanium-containing oxide are selected, and the amount of carbon regarding the selected particles is measured. There may be a case where the phase of niobium titanium-containing oxide does not include particulate forms, in which case, a region having a diffraction pattern assigned to the monoclinic niobium titanium-containing oxide is identified, for example, thereby distinguishing it from other active materials. The amount of carbon is measured regarding the identified region. In addition, the areas where carbon is present can be found by acquiring carbon mapping by EDX, when selecting the particles to be the measurement target, or identifying the region to be measured.

The weight of carbon that covers the surface of the oxide phase extracted in the above-described manner can be obtained as follows. First, the weight of the active material including the carbon-coated oxide phase (for example, oxide particles) is obtained as Wc. Next, the active material including the carbon-coated oxide phase is fired in air at a temperature of 800° C. for 3 hours. The carbon coating is thus burned off. By obtaining the weight after the firing, a weight W of the oxide before carbon coating can be obtained. A carbon-coat weight ratio on the oxide phase can be obtained from (Wc−W)/W.

<Method of Measuring Carboxyl Group in Carbon Coating Layer>

The amount of the carboxyl group in the carbon coating layer can be obtained by measuring the carbon amount by X-ray Photoelectron Spectroscopy (XPS) measurement and then selectively quantitatively analyzing the carboxyl group by a vapor-phase chemical modification method. Let Cₜₒₜₐₗ be the total carbon amount (number of atoms) based on a quantification result obtained by C1s peak fitting of XPS measurement. In the C1s peak fitting at this time, a COO component concentration [COO] is obtained. The thus obtained COO component includes functional groups other than the carboxyl group as well; however, by performing chemical modification using trifluoroethanol, the carboxyl group can be selectively quantified. Letting [COOH] be the carboxyl group amount (number of molecules) obtained by the quantification method, [COOH]/Cₜₒₜₐₗ×100% is defined as the carboxyl group concentration (molecular concentration) in the carbon coating layer. As described above, the concentration representing the carboxyl group content in the carbon coating layer is 0.001% or greater ([COOH]/Cₜₒₜₐₗ×100%), and is preferably 0.2% or greater, more preferably 1.6% or greater, and even more preferably 2.3% or greater. The carboxyl group concentration is preferably 10% or less. With the concentration being 10% or less, electrical conductivity of the carbon coating layer can be enhanced. The carboxyl group concentration is more preferably 5% or less, and even more preferably 3% or less.

<Method of Measuring Thickness of Carbon Coating Layer>

For measurement of the thickness of the carbon coating layer, for example, a Transmission Electron Microscope (TEM) is used.

Though the carbon coating layer is difficult to observe directly, the thickness thereof can be investigated by the following method. First, for example, Ru is deposited on an active material particle, and a particle cross-section is exposed by an FIB (Focused Ion Beam) processing. A gap observed between the deposited Ru and the oxide phase is examined from TEM images of the section. A point within one particle where the gap is most clearly distinguished is selected, and the gap is regarded as the carbon coating layer. Fifty active material particles extracted at random are observed by the same method, and the average value of the widths of gaps (the distance between the deposited Ru and the oxide phase) is taken as the thickness of the carbon coating layer.

The active material according to the first embodiment includes a monoclinic niobium titanium-containing oxide phase containing 0 ppm to 100 ppm of Na and a carbon coating layer containing 0.001% or more carboxyl groups. The carbon coating layer containing the carboxyl groups covers at least a part of a surface of the niobium titanium-containing phase. According to the active material, a secondary battery that exhibits high energy density and that is excellent in storage performance can be realized at low cost.

### Second Embodiment

According to a second embodiment, an electrode is provided.

The electrode according to the second embodiment includes the active material according to the first embodiment. This electrode may be a battery electrode including the active material according to the first embodiment as a battery active material. The electrode as the battery electrode may be, for example, a negative electrode including the active material according to the first embodiment as a negative electrode active material.

The electrode may include a current collector and an active material-containing layer. The active material-containing layer may be formed on both of reverse surfaces or one surface of the current collector. The active material-containing layer may contain the active material, and optionally an electro-conductive agent and a binder.

The active material-containing layer may contain the active material according to the first embodiment alone, or may contain two or more species of the active materials according to the first embodiment. Furthermore, the active material-containing layer may contain a mixture obtained by mixing one specie or two or more species of the active materials according to the first embodiment with one species or two or more species of other active materials. The proportion of contained active material(s) according to the first embodiment with respect to the total mass of the active material(s) according to the first embodiment and other active material(s) is desirably 50% by mass to 100% by mass.

For example, in a case where the active material according to the first embodiment is included as the negative electrode active material, examples of such other active materials include lithium titanate having a ramsdellite structure (e.g., Li_{2+y}Ti₃O₇, 0≤y≤3), lithium titanate having a spinel structure (e.g., Li₄₊ₓTi₅O₁₂, 0≤x≤3), titanium dioxide (TiO₂), anatase titanium dioxide, rutile titanium dioxide, niobium pentoxide (Nb₂O₅), hollandite titanium composite oxide, and orthorhombic titanium-containing composite oxide.

Examples of the orthorhombic titanium-containing composite oxide include a compound represented by Li₂₊ₐM_{2-b}^{I}Ti_{6-c}M_{d}^{II}O_{14+σ}. Here, M1 is at least one selected from the group consisting of Sr, Ba, Ca, Mg, Cs, Rb and K. M^{II} is at least one selected from the group consisting of Zr, Sn, V, Nb, Ta, Mo, W, Y, Fe, Co, Cr, Mn, Ni and Al. The respective subscripts in the composition formula are specified as follows: 0≤a≤6, 0≤b<2, 0≤c<6, 0≤d<6, and −0.5≤σ≤0.5.

The electro-conductive agent is added to improve current collection performance and to suppress the contact resistance between the active material and the current collector. Examples of the electro-conductive agent include carbonaceous substances such as vapor grown carbon fiber (VGCF), carbon blacks such as acetylene black, graphite, carbon nanotubes, and carbon nanofibers. One of these may be used as the electro-conductive agent, or alternatively, two or more may be used in combination as the electro-conductive agent. Alternatively, instead of using an electro-conductive agent, a carbon coating or an electro-conductive inorganic material coating may be further applied to the surface of the active material particle, in addition to the carbon coating layer including the carboxyl groups.

One or more fibrous carbon selected from the group consisting of carbon nanotubes and carbon nanofibers, which tends to make the electronic conductive network within the active material-containing layer better maintained, is preferably used as electro-conductive agent. In such a case, as explained for the first embodiment, since the carboxyl groups of the carbon coating layer of the active material adsorbs metal ions originating from residual catalyst metal, inexpensive fibrous carbon can also be used favorably.

The binder is added to fill gaps among the dispersed active material and also to bind the active material with the current collector. Examples of the binder include polytetrafluoroethylene (PTFE), polyvinylidene fluoride (PVdF), fluorine rubber, styrene-butadiene rubber, polyacrylate compounds, imide compounds, carboxymethyl cellulose (CMC), and salts of CMC. One of these may be used as the binder, or alternatively, two or more may be used in combination as the binder.

The blending proportions of active material, electro-conductive agent and binder in the active material-containing layer may be appropriately changed according to the use of the electrode. For example, in the case of using the electrode as a negative electrode of a secondary battery, the active material (negative electrode active material), electro-conductive agent and binder are preferably blended in proportions of 68% by mass to 96% by mass, 2% by mass to 30% by mass, and 2% by mass to 30% by mass, respectively. When the amount of electro-conductive agent is 2% by mass or more, the current collection performance of the active material-containing layer can be improved. When the amount of binder is 2% by mass or more, binding between the active material-containing layer and current collector is sufficient, whereby excellent cycling performances can be expected. On the other hand, an amount of each of the electro-conductive agent and binder is preferably 30% by mass or less, in view of increasing the capacity.

There may be used for the current collector, a material which is electrochemically stable at the potential (vs. Li/Li⁺) at which lithium (Li) is inserted into and extracted from the active material. For example in the case where the active material is used as a negative electrode active material, the current collector is preferably made of copper, nickel, stainless steel, aluminum, or an aluminum alloy including one or more elements selected from the group consisting of Mg, Ti, Zn, Mn, Fe, Cu, and Si. The thickness of the current collector is preferably from 5 μm to 20 μm. The current collector having such a thickness can maintain balance between the strength and weight reduction of the electrode.

The current collector may include a portion where the negative electrode active material-containing layer is not formed on a surface thereof. This portion may serve as a negative electrode current collecting tab.

The electrode may be fabricated by the following method, for example. First, active material, electro-conductive agent, and binder are suspended in a solvent to prepare a slurry. The slurry is applied onto one surface or both of reverse surfaces of a current collector. Next, the applied slurry is dried so as to obtain a stack formed of active material-containing layer and current collector. Then, the stack is subjected to pressing. The electrode can be fabricated in this manner.

Alternatively, the electrode may also be fabricated by the following method. First, active material, electro-conductive agent, and binder are mixed to obtain a mixture. Next, the mixture is formed into pellets. Then the electrode can be obtained by arranging the pellets onto the current collector.

The electrode according to the second embodiment includes the active material according to the first embodiment. Therefore, the electrode can realize a secondary battery that exhibits high energy density and that is excellent in storage performance, at low cost.

### Third Embodiment

According to a third embodiment, there is provided a secondary battery including a negative electrode, a positive electrode, and an electrolyte. As the negative electrode, the secondary battery includes the electrode according to the second embodiment. That is, the secondary battery according to the third embodiment includes as the negative electrode, an electrode that includes the active material according to the first embodiment as a battery active material.

The secondary battery may further include a separator provided between the positive electrode and the negative electrode. The negative electrode, the positive electrode, and the separator may configure an electrode group. The electrolyte may be held in the electrode group.

The secondary battery may further include a container member that houses the electrode group and the electrolyte.

The secondary battery may further include a negative electrode terminal electrically connected to the negative electrode and a positive electrode terminal electrically connected to the positive electrode.

The secondary battery may be, for example, a lithium secondary battery. The secondary battery also includes nonaqueous electrolyte secondary batteries including nonaqueous electrolyte(s).

Hereinafter, the negative electrode, positive electrode, electrolyte, separator, container member, negative electrode terminal, and positive electrode terminal will be described in detail.

1) Negative Electrode

The negative electrode may include a negative electrode current collector and a negative electrode active material-containing layer. The negative electrode current collector and the negative electrode active material-containing layer may respectively be the current collector and active material-containing layer that may be included in the electrode according to the second embodiment. The negative electrode active material-containing layer contains the active material according to the first embodiment as negative electrode active material.

Of the details of the negative electrode, portions that overlap with the details described in the second embodiment are omitted.

The density of the negative electrode active material-containing layer (excluding the current collector) is preferably from 1.8 g/cm³ to 2.8 g/cm³. The negative electrode having the density of the negative electrode active material-containing layer within this range, is excellent in energy density and ability of holding the electrolyte. The density of the negative electrode active material-containing layer is more preferably from 2.1 g/cm³ to 2.6 g/cm³.

The negative electrode may, for example, be fabricated by the same method as that for the electrode according to the second embodiment.

2) Positive Electrode

The positive electrode may include a positive electrode current collector and a positive electrode active material-containing layer. The positive electrode active material-containing layer may be formed on one surface or both of reverse surfaces of the positive electrode current collector. The positive electrode active material-containing layer may include a positive electrode active material, and optionally an electro-conductive agent and a binder.

As the positive electrode active material, for example, an oxide or a sulfide may be used. The positive electrode may singly include one species of compound as the positive electrode active material, or alternatively, include two or more species of compounds in combination. Examples of the oxide and sulfide include compounds capable of having Li and Li ions be inserted and extracted.

Examples of such compounds include manganese dioxide (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese cobalt composite oxides (e.g., LiₓMn_{y}Co_{1-y}O₂; 0<x≤1, 0<y<1), lithium manganese nickel composite oxides having a spinel structure (e.g., LiₓMn_{2-y}Ni_{y}O₄; 0<x≤1, 0<y<2), lithium phosphates having an olivine structure (e.g., LiₓFePO₄; 0<x≤1, LiₓFe_{1-y}Mn_{y}PO₄; 0<x≤1, 0<y≤1, and LiₓCoPO₄; 0<x≤1), iron sulfate (Fe₂(SO₄)₃), vanadium oxides (e.g., V₂O₅), and lithium nickel cobalt manganese composite oxide (LiₓNi_{1-y-z}Co_{y}Mn_{z}O₂; 0<x≤1, 0<y<1, 0<z<1, y+z<1).

Among the above, examples of compounds more preferable as the positive electrode active material include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese nickel composite oxides having a spinel structure (e.g., LiₓMn_{2-y}Ni_{y}O₄; 0<x≤1, 0<y<2), lithium manganese cobalt composite oxide (e.g., LiₓMn_{y}Co_{1-y}O₂; 0<x≤1, 0<y<1), lithium iron phosphates (e.g., LiₓFePO₄; 0<x≤1), and lithium nickel cobalt manganese composite oxides (LiₓNi_{1-y-z}Co_{y}Mn_{z}O₂; 0<x≤1, 0<y<1, 0<z<1, y+z<1). The positive electrode potential can be made high by using these positive electrode active materials.

When an ambient temperature molten salt is used as the electrolyte of the battery, it is preferable to use a positive electrode active material including lithium iron phosphate, LiₓVPO₄F (0≤x≤1), lithium manganese composite oxide, lithium nickel composite oxide, lithium nickel cobalt composite oxide, or a mixture thereof. Since these compounds have low reactivity with ambient temperature molten salts, cycle life can be improved. Details regarding the ambient temperature molten salt are described later.

The primary particle diameter of the positive electrode active material is preferably from 100 nm to 1 μm. The positive electrode active material having a primary particle size of 100 nm or more is easy to handle during industrial production. In the positive electrode active material having a primary particle size of 1 μm or less, in-solid diffusion of lithium ions can proceed smoothly.

The specific surface area of the positive electrode active material is preferably from 0.1 m²/g to 10 m²/g. With the positive electrode active material having a specific surface area of 0.1 m²/g or more, sufficient sites for inserting and extracting Li ions can be secured. The positive electrode active material having a specific surface area of 10 m²/g or less is easy to handle during industrial production, and can secure a good charge and discharge cycle performance.

The binder is added to fill gaps among the dispersed positive electrode active material and also to bind the positive electrode active material with the positive electrode current collector. Examples of the binder include polytetrafluoroethylene (PTFE), polyvinylidene fluoride (PVdF), fluororubber, polyacrylate compounds, imide compounds, carboxymethyl cellulose (CMC), and salts of CMC. One of these may be used as the binder, or alternatively, two or more may be used in combination as the binder.

The electro-conductive agent is added to improve current collection performance and to suppress the contact resistance between the positive electrode active material and the positive electrode current collector. Examples of electro-conductive agent include carbonaceous substances such as vapor grown carbon fiber (VGCF), carbon black such as acetylene black, and graphite. One of these may be used as the electro-conductive agent, or two or more may be used in combination as the electro-conductive agent. The electro-conductive agent may be omitted.

In the positive electrode active material-containing layer, the positive electrode active material and binder are preferably blended in proportions of 80% by mass to 98% by mass, and 2% by mass to 20% by mass, respectively.

When the amount of the binder is 2% by mass or more, sufficient electrode strength can be achieved. The binder may serve as an electrical insulator. Thus, when the amount of the binder is 20% by mass or less, the amount of insulator in the electrode is reduced, and thereby the internal resistance can be decreased.

When an electro-conductive agent is added, the positive electrode active material, binder, and electro-conductive agent are preferably blended in proportions of 77% by mass to 95% by mass, 2% by mass to 20% by mass, and 3% by mass to 15% by mass, respectively.

When the amount of the electro-conductive agent is 3% by mass or more, the above-described effects can be expressed. By setting the amount of the electro-conductive agent to 15% by mass or less, the proportion of electro-conductive agent that contacts the electrolyte can be made low. When this proportion is low, decomposition of electrolyte can be reduced during storage under high temperatures.

The positive electrode current collector is preferably an aluminum foil, or an aluminum alloy foil containing one or more selected from the group consisting of Mg, Ti, Zn, Ni, Cr, Mn, Fe, Cu, and Si.

The thickness of the aluminum foil or aluminum alloy foil is preferably from 5 μm to 20 μm, and more preferably 15 μm or less. The purity of the aluminum foil is preferably 99% by mass or more. The amount of transition metal such as iron, copper, nickel, or chromium contained in the aluminum foil or aluminum alloy foil is preferably 1% by mass or less.

The positive electrode current collector may include a portion where a positive electrode active material-containing layer is not formed on a surface thereof. This portion may serve as a positive electrode current collecting tab.

The positive electrode may be fabricated by a method similar to that for the electrode according to the second embodiment, for example, using a positive electrode active material.

3) Electrolyte

As the electrolyte, for example, a liquid nonaqueous electrolyte or gel nonaqueous electrolyte may be used. The liquid nonaqueous electrolyte is prepared by dissolving an electrolyte salt as solute in an organic solvent. The concentration of electrolyte salt is preferably from 0.5 mol/L to 2.5 mol/L.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide (LiN(CF₃SO₂)₂), and mixtures thereof. The electrolyte salt is preferably resistant to oxidation even at a high potential, and most preferably LiPF₆.

Examples of the organic solvent include cyclic carbonates such as propylene carbonate (PC), ethylene carbonate (EC), and vinylene carbonate (VC); linear carbonates such as diethyl carbonate (DEC), dimethyl carbonate (DMC), and methyl ethyl carbonate (MEC); cyclic ethers such as tetrahydrofuran (THF), 2-methyl tetrahydrofuran (2-MeTHF), and dioxolane (DOX); linear ethers such as dimethoxy ethane (DME) and diethoxy ethane (DEE); γ-butyrolactone (GBL), acetonitrile (AN), and sulfolane (SL). These organic solvents may be used singularly or as a mixed solvent.

The gel nonaqueous electrolyte is prepared by obtaining a composite of a liquid nonaqueous electrolyte and a polymeric material. Examples of the polymeric material include polyvinylidene fluoride (PVdF), polyacrylonitrile (PAN), polyethylene oxide (PEO), and mixtures thereof.

Alternatively, other than the liquid nonaqueous electrolyte and gel nonaqueous electrolyte, an ambient temperature molten salt (ionic melt) including lithium ions, a polymer solid electrolyte, an inorganic solid electrolyte, or the like may be used as the nonaqueous electrolyte.

The ambient temperature molten salt (ionic melt) indicates compounds among organic salts made of combinations of organic cations and anions, which are able to exist in a liquid state at ambient temperature (15° C. to 25° C.). The ambient temperature molten salt includes an ambient temperature molten salt which exists alone as a liquid, an ambient temperature molten salt which becomes a liquid upon mixing with an electrolyte salt, an ambient temperature molten salt which becomes a liquid when dissolved in an organic solvent, and mixtures thereof. In general, the melting point of the ambient temperature molten salt used in secondary batteries is 25° C. or below. The organic cations generally have a quaternary ammonium framework.

The polymer solid electrolyte is prepared by dissolving the electrolyte salt in a polymeric material, and solidifying it.

The inorganic solid electrolyte is a solid substance having Li ion conductivity. Having Li ion conductivity, as referred to herein, indicates exhibiting a lithium ion conductivity of 1×10⁻⁶ S/cm or more at 25° C. Examples of the inorganic solid electrolyte include oxide solid electrolytes and sulfide solid electrolytes. Specific examples of the inorganic solid electrolyte are described below.

Preferably used as the oxide solid electrolyte is a lithium phosphate solid electrolyte having a NASICON (Sodium (Na) Super Ionic Conductor) structure represented by a general formula Li₁₊ₓMα₂(PO₄)₃. Mα in the above general formula is, for example, one or more selected from the group consisting of titanium (Ti), germanium (Ge), strontium (Sr), zirconium (Zr), tin (Sn), aluminum (Al), and calcium (Ca). The subscript x is within the range of 0≤x≤2.

Specific examples of the lithium phosphate solid electrolyte having the NASICON structure include a LATP compound represented by Li₁₊ₓAlₓTi₂₋ₓ(PO₄)₃ where 0.1≤x≤0.5; a compound represented by Li₁₊ₓAl_{y}Mβ_{2-y}(PO₄)₃ where Mβ is one or more selected from the group consisting of Ti, Ge, Sr, Zr, Sn, and Ca, 0≤x≤1, and 0≤y≤1; a compound represented by Li₁₊ₓAlₓGe₂₋ₓ(PO₄)₃ where 0≤x≤2; a compound represented by Li₁₊ₓAlₓZr₂₋ₓ(PO₄)₃ where 0≤x≤2; a compound represented by Li₁₊ₓ+_{y}AlₓMγ₂₋ₓSi_{y}P_{3-y}O₁₂ where Mγ is one or more selected from the group consisting of Ti and Ge, 0<x≤2, and 0≤y<3; and a compound represented by Li₁₊₂ₓZr₁₋ₓCaₓ(PO₄)₃ where 0≤x<1.

In addition to the above lithium phosphate solid electrolyte, examples of the oxide solid electrolyte include amorphous LIPON compounds represented by LiₓPO_{y}N_{z} where 2.6≤x≤3.5, 1.9≤y≤3.8, and 0.1≤z≤1.3 (e.g., Li_{2.9}PO_{3.3}N_{0.46}); a compound having a garnet structure represented by La₅₊ₓAₓLa₃₋ₓMδ₂O₁₂ where A is one or more selected from the group consisting of Ca, Sr, and Ba, Mδ is one or more selected from the group consisting of Nb and Ta, and 0≤x≤0.5; a compound represented by Li₃Mδ₂₋ₓL₂O₁₂ where Mδ is one or more selected from the group consisting of Nb and Ta, L may include Zr, and 0≤x≤0.5; a compound represented by Li₇₋₃ₓAlₓLa₃Zr₃O₁₂ where 0≤x≤0.5; a LLZ compound represented by Li₅₊ₓLa₃Mδ₂₋ₓZrₓO₁₂ where Mδ is one or more selected from the group consisting of Nb and Ta, and 0≤x≤2 (e.g., Li₇La₃Zr₂O₁₂); and a compound having a perovskite structure and represented by La_{2/3-x}LiₓTiO₃ where 0.3≤x≤0.7.

One or more among the above compounds may be used as the solid electrolyte. Two or more of the above solid electrolytes may be used, as well.

4) Separator

The separator may be made of, for example, a porous film or synthetic resin nonwoven fabric including polyethylene (PE), polypropylene (PP), cellulose, or polyvinylidene fluoride (PVdF). In view of safety, a porous film made of polyethylene or polypropylene is preferred. This is because at a certain temperature, such a porous film melts and can thereby shut off current.

5) Container Member

As the container member, for example, a container made of laminate film or a container made of metal may be used.

The thickness of the laminate film is, for example, 0.5 mm or less, and preferably 0.2 mm or less.

As the laminate film, used is a multilayer film including multiple resin layers and a metal layer sandwiched between the resin layers. The resin layer may include, for example, a polymeric material such as polypropylene (PP), polyethylene (PE), nylon, or polyethylene terephthalate (PET). The metal layer is preferably made of aluminum foil or an aluminum alloy foil, so as to reduce weight. The laminate film may be formed into the shape of a container member, by heat-sealing.

The wall thickness of the metal container is, for example, 1 mm or less, more preferably 0.5 mm or less, and still more preferably 0.2 mm or less.

The metal container is made, for example, of aluminum or an aluminum alloy. The aluminum alloy preferably contains elements such as magnesium, zinc, or silicon. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), prismatic, cylindrical, coin-shaped, or button-shaped. The container member may be appropriately selected depending on battery size and use of the battery.

6) Negative Electrode Terminal

The negative electrode terminal may be made of a material that is electrochemically stable at the Li insertion-extraction potential of the negative electrode active materials mentioned above, and having electrical conductivity. Specific examples of the material for the negative electrode terminal include copper, nickel, stainless steel, aluminum, and aluminum alloy containing at least one selected from the group consisting of Mg, Ti, Zn, Mn, Fe, Cu, and Si. Aluminum or aluminum alloy is preferred as the material for the negative electrode terminal. The negative electrode terminal is preferably made of the same material as the negative electrode current collector, in order to reduce the contact resistance between the negative electrode terminal and the negative electrode current collector.

7) Positive Electrode Terminal

The positive electrode terminal may be made of, for example, a material that is electrically stable in the potential range of 3 V to 4.5 V (vs. Li/Li⁺) relative to the oxidation-reduction potential of lithium, and having electrical conductivity. Examples of the material for the positive electrode terminal include aluminum and an aluminum alloy containing one or more selected from the group consisting of Mg, Ti, Zn, Mn, Fe, Cu, and Si. The positive electrode terminal is preferably made of the same material as the positive electrode current collector, in order to reduce contact resistance between the positive electrode terminal and the positive electrode current collector.

Next, the secondary battery according to the embodiment will be more concretely described with reference to the drawings.

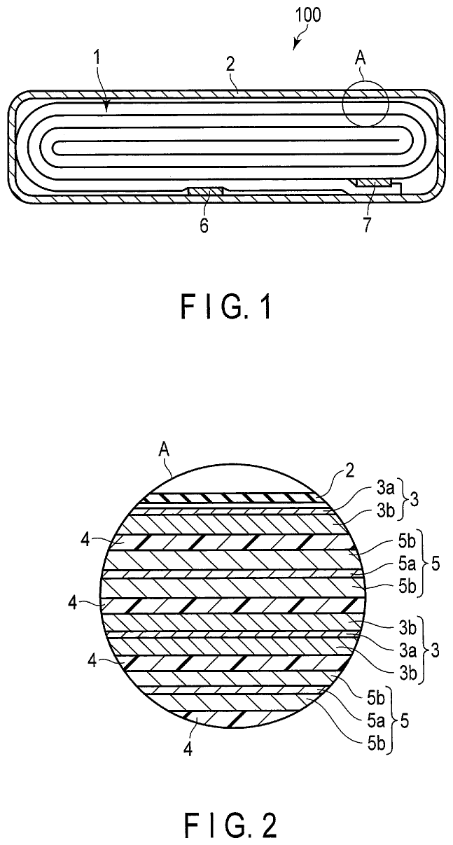

FIG. 1 is a cross-sectional view schematically showing an example of the secondary battery. FIG. 2 is an enlarged cross-sectional view of section A of the secondary battery shown in FIG. 1.

The secondary battery 100 shown in FIGS. 1 and 2 includes a bag-shaped container member 2 shown in FIG. 1, an electrode group 1 shown in FIGS. 1 and 2, and an electrolyte, which is not shown. The electrode group 1 and the electrolyte are housed in the bag-shaped container member 2. The electrolyte (not shown) is held in the electrode group 1.

The bag-shaped container member 2 is made of a laminate film including two resin layers and a metal layer sandwiched between the resin layers.

As shown in FIG. 1, the electrode group 1 is a wound electrode group in a flat form. The wound electrode group 1 in a flat form includes a negative electrode 3, a separator 4, and a positive electrode 5, as shown in FIG. 2. The separator 4 is sandwiched between the negative electrode 3 and the positive electrode 5.

The negative electrode 3 includes a negative electrode current collector 3a and a negative electrode active material-containing layer 3b. At the portion of the negative electrode 3 positioned outermost among the wound electrode group 1, the negative electrode active material-containing layer 3b is formed only on an inner surface of the negative electrode current collector 3a, as shown in FIG. 2. For the other portions of the negative electrode 3, negative electrode active material-containing layers 3b are formed on both of reverse surfaces of the negative electrode current collector 3a.

The positive electrode 5 includes a positive electrode current collector 5a and positive electrode active material-containing layers 5b formed on both of reverse surfaces of the positive electrode current collector 5a.

As shown in FIG. 1, a negative electrode terminal 6 and positive electrode terminal 7 are positioned in vicinity of the outer peripheral edge of the wound electrode group 1. The negative electrode terminal 6 is connected to a portion of the negative electrode current collector 3a positioned outermost. The positive electrode terminal 7 is connected to a portion of the positive electrode current collector 5a positioned outermost. The negative electrode terminal 6 and the positive electrode terminal 7 extend out from an opening of the bag-shaped container member 2. A thermoplastic resin layer is provided on the inner surface of the bag-shaped container member 2, and the opening is sealed by heat-sealing the resin layer.

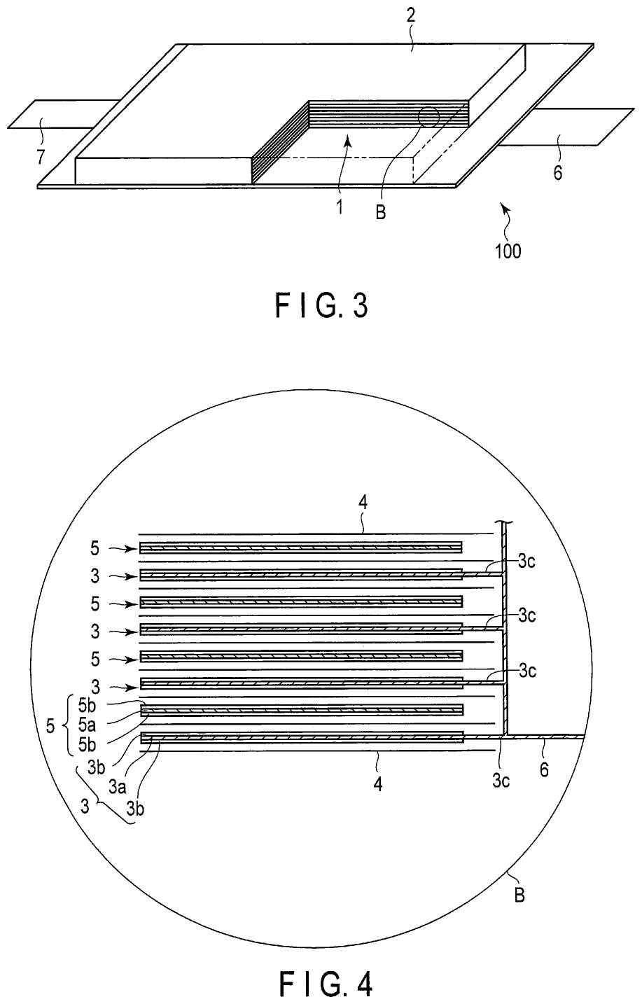

The secondary battery according to the embodiment is not limited to the secondary battery of the structure shown in FIGS. 1 and 2, and may be, for example, a battery of a structure as shown in FIGS. 3 and 4.

FIG. 3 is a partially cut-out perspective view schematically showing another example of the secondary battery. FIG. 4 is an enlarged cross-sectional view of section B of the secondary battery shown in FIG. 3.

The secondary battery 100 shown in FIGS. 3 and 4 includes an electrode group 1 shown in FIGS. 3 and 4, a container member 2 shown in FIG. 3, and an electrolyte, which is not shown. The electrode group 1 and electrolyte are housed in the container member 2. The electrolyte is held in the electrode group 1.

The container member 2 is made of a laminate film including two resin layers and a metal layer sandwiched between the resin layers.

As shown in FIG. 4, the electrode group 1 is a stacked electrode group. The stacked electrode group 1 has a structure in which negative electrodes 3 and positive electrodes 5 are alternately stacked with separator(s) 4 sandwiched therebetween.

The electrode group 1 includes plural negative electrodes 3. Each of the negative electrodes 3 includes the negative electrode current collector 3a and the negative electrode active material-containing layers 3b supported on both surfaces of the negative electrode current collector 3a. The electrode group 1 further includes plural positive electrodes 5. Each of the positive electrodes 5 includes the positive electrode current collector 5a and the positive electrode active material-containing layers 5b supported on both surfaces of the positive electrode current collector 5a.

The negative electrode current collector 3a of each of the negative electrodes 3 includes at one end, a portion where the negative electrode active material-containing layer 3b is not supported on either surface. This portion serves as a negative electrode current collecting tab 3c. As shown in FIG. 4, the negative electrode current collecting tabs 3c do not overlap the positive electrodes 5. The plural negative electrode current collecting tabs 3c are electrically connected to the strip-shaped negative electrode terminal 6. A tip of the strip-shaped negative electrode terminal 6 is drawn outside from the container member 2.

Although not shown, the positive electrode current collector 5a of each of the positive electrodes 5 includes at one end, a portion where the positive electrode active material-containing layer 5b is not supported on either surface. This portion serves as a positive electrode current collecting tab. Like the negative electrode current collecting tabs 3c, the positive electrode current collecting tabs do not overlap the negative electrodes 3. Further, the positive electrode current collecting tabs are located on the opposite side of the electrode group 1 with respect to the negative electrode current collecting tabs 3c. The positive electrode current collecting tabs are electrically connected to the strip-shaped positive electrode terminal 7. A tip of the strip-shaped positive electrode terminal 7 is located on the opposite side relative to the negative electrode terminal 6 and drawn outside from the container member 2.

The secondary battery according to the third embodiment includes the electrode according to the second embodiment as the negative electrode. Therefore, the secondary battery exhibits high energy density and is excellent in storage performance. In addition, the secondary battery can be provided at low cost.

### Fourth Embodiment

According to a fourth embodiment, a battery module is provided. The battery module includes plural of secondary batteries according to the third embodiment.

In the battery module, each of the single-batteries may be arranged to be electrically connected in series or in parallel, or may be arranged in combination of in-series connection and in-parallel connection.

An example of the battery module according to the embodiment will be described next, with reference to the drawings.

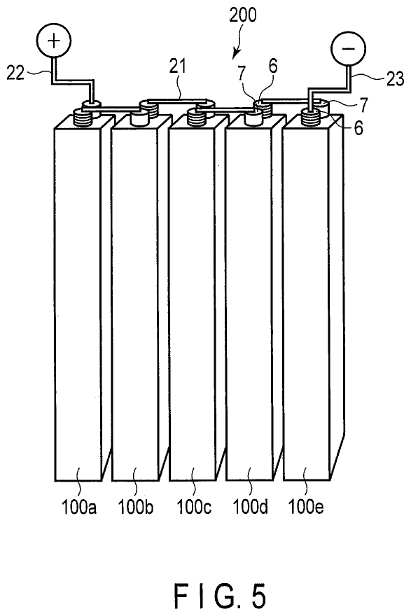

FIG. 5 is a perspective view schematically showing an example of the battery module. The battery module 200 shown in FIG. 5 includes five single-batteries 100a to 100e, four bus bars 21, a positive electrode-side lead 22, and a negative electrode-side lead 23. Each of the five single-batteries 100a to 100e is the secondary battery according to the third embodiment.

The bus bar 21 connects, for example, a negative electrode terminal 6 of one single-battery 100a and a positive electrode terminal 7 of the single-battery 100b positioned adjacent. In such a manner, five single-batteries 100 are thus connected in series by the four bus bars 21. That is, the battery module 200 shown in FIG. 5 is a battery module of five-in-series connection. Although no example is depicted in drawing, in a battery module including plural single-batteries that are electrically connected in parallel, for example, the plural single-batteries may be electrically connected by having plural negative electrode terminals being connected to each other by bus bars while having plural positive electrode terminals being connected to each other by bus bars.

The positive electrode terminal 7 of at least one battery among the five single-batteries 100a to 100e is electrically connected to the positive electrode-side lead 22 for external connection. In addition, the negative electrode terminal 6 of at least one battery among the five single-batteries 100a to 100e is electrically connected to the negative electrode-side lead 23 for external connection.

The battery module according to the fourth embodiment includes the secondary battery according to the third embodiment. Therefore, the battery module can exhibit high energy density and is excellent in storage performance. In addition, the battery module can be provided at low cost.

### Fifth Embodiment

According to a fifth embodiment, a battery pack is provided. The battery pack includes a battery module according to the fourth embodiment. The battery pack may include a single secondary battery according to the third embodiment, in place of the battery module according to the fourth embodiment.

The battery pack may further include a protective circuit. The protective circuit has a function to control charging and discharging of the secondary battery. Alternatively, a circuit included in equipment where the battery pack serves as a power source (for example, electronic devices, automobiles, and the like) may be used as the protective circuit for the battery pack.

Moreover, the battery pack may further include an external power distribution terminal. The external power distribution terminal is configured to externally output current from the secondary battery, and/or to input external current into the secondary battery. In other words, when the battery pack is used as a power source, the current is provided out via the external power distribution terminal. When the battery pack is charged, the charging current (including regenerative energy of motive force of vehicles such as automobiles) is provided to the battery pack via the external power distribution terminal.

Next, an example of a battery pack according to the embodiment will be described with reference to the drawings.

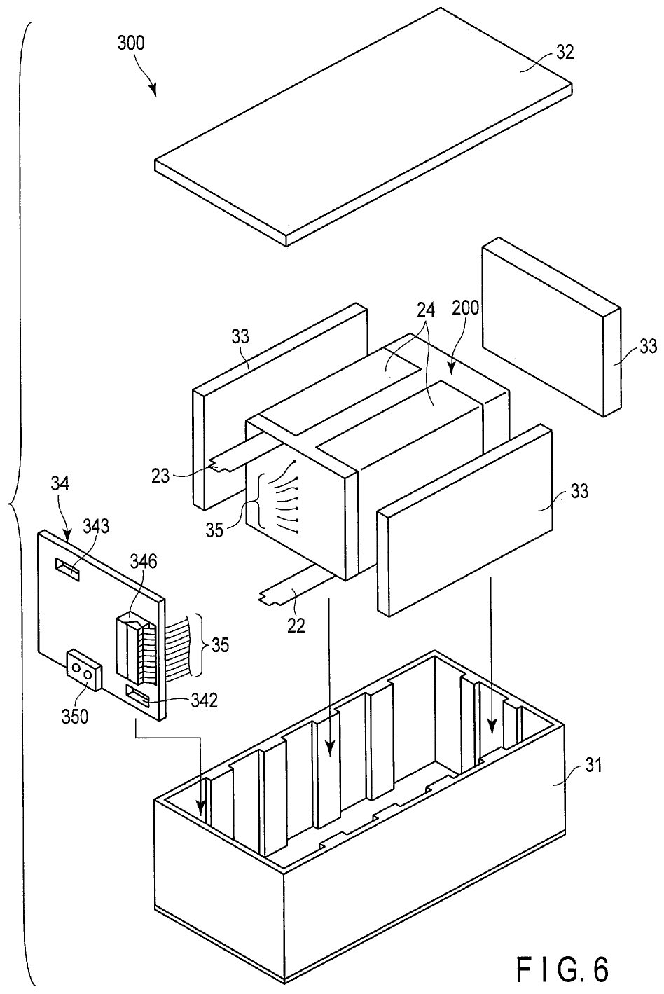

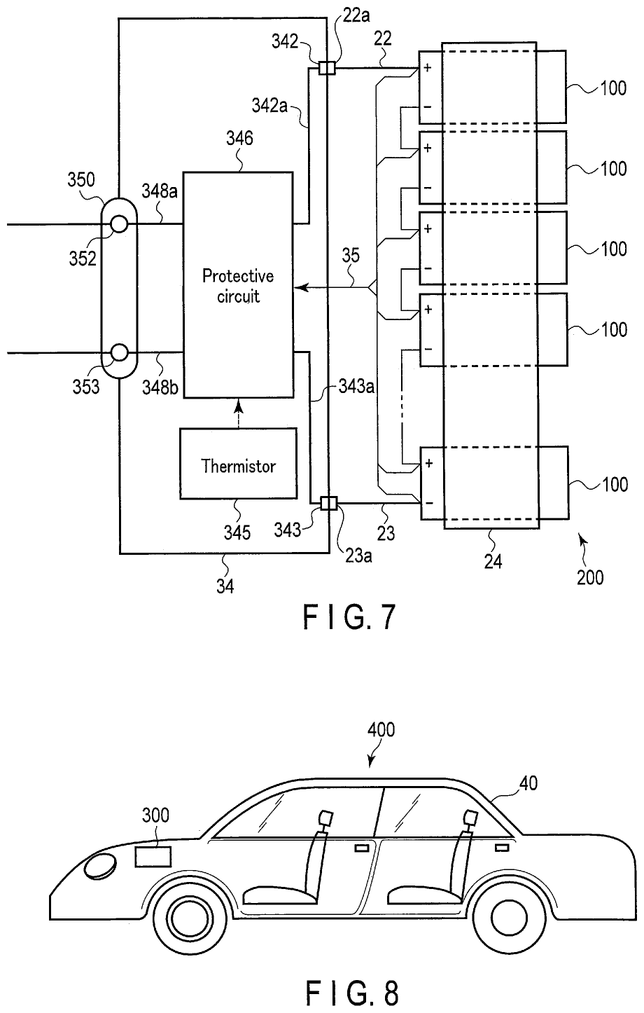

FIG. 6 is an exploded perspective view schematically showing an example of the battery pack. FIG. 7 is a block diagram showing an example of an electric circuit of the battery pack shown in FIG. 6.

A battery pack 300 shown in FIGS. 6 and 7 includes a housing container 31, a lid 32, protective sheets 33, a battery module 200, a printed wiring board 34, wires 35, and an insulating plate (not shown).

The housing container 31 shown in FIG. 6 is a prismatic bottomed container having a rectangular bottom surface. The housing container 31 is configured to be capable of housing the protective sheets 33, the battery module 200, the printed wiring board 34, and the wires 35. The lid 32 has a rectangular shape. The lid 32 covers the housing container 31 to house the battery module 200 and such. Although not illustrated, the housing container 31 and the lid 32 are provided with openings, connection terminals, or the like for connection to an external device or the like.

The battery module 200 includes plural single-batteries 100, a positive electrode-side lead 22, a negative electrode-side lead 23, and adhesive tapes 24.

At least one of the plural single-batteries 100 is a secondary battery according to the third embodiment. The plural single-batteries 100 are electrically connected in series, as shown in FIG. 7. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tapes 24 fasten the plural single-batteries 100. The plural single-batteries 100 may be fixed using a heat shrinkable tape in place of the adhesive tapes 24. In this case, protective sheets 33 are arranged on both side surfaces of the battery module 200, and the heat shrinkable tape is wound around the battery module 200 and protective sheets 33. After that, the heat shrinkable tape is shrunk by heating to bundle the plural single-batteries 100.

One end of the positive electrode-side lead 22 is connected to the battery module 200. The one end of the positive electrode-side lead 22 is electrically connected to the positive electrode(s) of one or more single-battery 100. One end of the negative electrode-side lead 23 is connected to the battery module 200. The one end of the negative electrode-side lead 23 is electrically connected to the negative electrode(s) of one or more single-battery 100.

The printed wiring board 34 is provided along one face in the short side direction among the inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side wiring (positive-side wiring) 348a, and a minus-side wiring (negative-side wiring) 348b. One principal surface of the printed wiring board 34 faces a surface of the battery module 200. An insulating plate (not shown) is disposed in between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode-side connector 343.

The thermistor 345 is fixed to one principal surface of the printed wiring board 34. The thermistor 345 detects the temperature of each single-battery 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the plural single-batteries 100 via the wires 35.

The protective sheets 33 are arranged on both inner surfaces of the housing container 31 along the long side direction and on the inner surface along the short side direction facing the printed wiring board 34 across the battery module 200. The protective sheets 33 are made of, for example, resin or rubber.

The protective circuit 346 controls charge and discharge of the plural single-batteries 100. The protective circuit 346 is also configured to cut-off electric connection between the protective circuit 346 and the external power distribution terminal 350 (positive-side terminal 352, negative-side terminal 353) to external device(s), based on detection signals transmitted from the thermistor 345 or detection signals transmitted from each single-battery 100 or the battery module 200.

An example of the detection signal transmitted from the thermistor 345 is a signal indicating that the temperature of the single-battery(s) 100 is detected to be a predetermined temperature or more. An example of the detection signal transmitted from each single-battery 100 or the battery module 200 include a signal indicating detection of over-charge, over-discharge, and overcurrent of the single-battery(s) 100. When detecting over charge or the like for each of the single batteries 100, the battery voltage may be detected, or a positive electrode potential or negative electrode potential may be detected. In the latter case, a lithium electrode to be used as a reference electrode may be inserted into each single-battery 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode-side lead 22 and the negative electrode-side lead 23 may respectively be used as the positive-side terminal 352 and negative-side terminal 353 of the external power distribution terminal 350.

Such a battery pack is used, for example, in applications where excellent cycle performance is demanded when a large current is extracted. More specifically, the battery pack is used as, for example, a power source for electronic devices, a stationary battery, or an onboard battery for various kinds of vehicles. An example of the electronic device is a digital camera. The battery pack is particularly favorably used as an onboard battery.

The battery pack according to the fifth embodiment is provided with the secondary battery according to the third embodiment or the battery module according to the fourth embodiment. Accordingly, the battery pack can exhibit high energy density and is excellent in storage performance. In addition, the battery pack can be provided at low cost.

### Sixth Embodiment

According to a sixth embodiment, a vehicle is provided. The battery pack according to the fifth embodiment is installed on this vehicle.

In the vehicle, the battery pack is configured, for example, to recover regenerative energy from motive force of the vehicle. The vehicle may include a mechanism (a regenerator) configured to convert kinetic energy of the vehicle into regenerative energy.

Examples of the vehicle include two-wheeled to four-wheeled hybrid electric automobiles, two-wheeled to four-wheeled electric automobiles, electrically assisted bicycles, and railway cars.

The installing position of the battery pack within the vehicle is not particularly limited. For example, when installing the battery pack on an automobile, the battery pack may be installed in the engine compartment of the automobile, in rear parts of the vehicle body, or under seats.

Plural battery packs may installed in the vehicle. In such a case, batteries included in each of the battery packs may be electrically connected to each other in series, electrically connected in parallel, or electrically connected in a combination of in-series connection and in-parallel connection. For example, in a case where each battery pack includes a battery module, the battery modules may be electrically connected to each other in series, electrically connected in parallel, or electrically connected in a combination of in-series connection and in-parallel connection. Alternatively, in a case where each battery pack includes a single battery, each of the batteries may be electrically connected to each other in series, electrically connected in parallel, or electrically connected in a combination of in-series connection and in-parallel connection.

An example of the vehicle is explained below, with reference to the drawings.

FIG. 8 is a partially see-through diagram schematically showing an example of the vehicle.

A vehicle 400, shown in FIG. 8 includes a vehicle body 40 and a battery pack 300 according to the fifth embodiment. In the example shown in FIG. 8, the vehicle 400 is a four-wheeled automobile.

This vehicle 400 may have plural battery packs 300 installed therein. In such a case, the batteries (e.g., single-batteries or battery module) included in the battery packs 300 may be connected in series, connected in parallel, or connected in a combination of in-series connection and in-parallel connection.

In FIG. 8, depicted is an example where the battery pack 300 is installed in an engine compartment located at the front of the vehicle body 40. As mentioned above, for example, the battery pack 300 may be alternatively installed in rear sections of the vehicle body 40, or under a seat. The battery pack 300 may be used as a power source of the vehicle 400. The battery pack 300 can also recover regenerative energy of motive force of the vehicle 400.

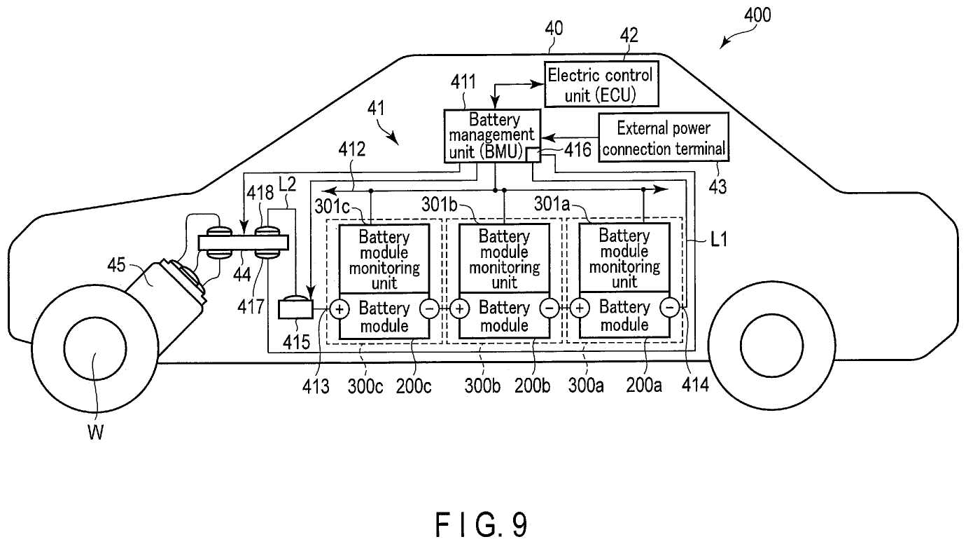

Next, with reference to FIG. 9, an aspect of operation of the vehicle according to the embodiment is explained.

FIG. 9 is a diagram schematically showing an example of a control system related to an electric system in the vehicle. A vehicle 400, shown in FIG. 9, is an electric automobile.

The vehicle 400, shown in FIG. 9, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 9, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

The battery pack 300a includes a battery module 200a and a battery module monitoring unit 301a (e.g., a VTM: voltage temperature monitoring). The battery pack 300b includes a battery module 200b and a battery module monitoring unit 301b. The battery pack 300c includes a battery module 200c and a battery module monitoring unit 301c. The battery packs 300a to 300c are battery packs similar to the aforementioned battery pack 300, and the battery modules 200a to 200c are battery modules similar to the aforementioned battery module 200. The battery modules 200a to 200c are electrically connected in series. The battery packs 300a, 300b and 300c can each be independently removed, and may be exchanged by a different battery pack 300.

Each of the battery modules 200a to 200c includes plural single-batteries connected in series. At least one of the plural single-batteries is the secondary battery according to the third embodiment. The battery modules 200a to 200c each perform charging and discharging via a positive electrode terminal 413 and a negative electrode terminal 414.

The battery management unit 411 performs communication with the battery module monitoring units 301a to 301c and collects information such as voltages or temperatures for each of the single-batteries 100 included in the battery modules 200a to 200c included in the vehicle power source 41. In this manner, the battery management unit 411 collects information concerning security of the vehicle power source 41.

The battery management unit 411 and the battery module monitoring units 301a to 301c are connected via the communication bus 412. In the communication bus 412, a set of communication lines is shared at multiple nodes (i.e., the battery management unit 411 and one or more battery module monitoring units 301a to 301c). The communication bus 412 is, for example, a communication bus configured based on CAN (Control Area Network) standard.

The battery module monitoring units 301a to 301c measure a voltage and a temperature of each single-battery in the battery modules 200a to 200c based on commands from the battery management unit 411. It is possible, however, to measure the temperatures only at several points per battery module, and the temperatures of all of the single-batteries need not be measured.

The vehicle power source 41 may also have an electromagnetic contactor (for example, a switch unit 415 shown in FIG. 9) for switching on and off electrical connection between the positive electrode terminal 413 and the negative electrode terminal 414. The switch unit 415 includes a precharge switch (not shown), which is turned on when the battery modules 200a to 200c are charged, and a main switch (not shown), which is turned on when output from the battery modules 200a to 200c is supplied to a load. The precharge switch and the main switch each include a relay circuit (not shown), which is switched on or off based on a signal provided to a coil disposed near the switch elements. The magnetic contactor such as the switch unit 415 is controlled based on control signals from the battery management unit 411 or the vehicle ECU 42, which controls the operation of the entire vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management unit 411 or the vehicle ECU 42, which controls the entire operation of the vehicle. Due to the inverter 44 being controlled, output voltage from the inverter 44 is adjusted.

The drive motor 45 is rotated by electric power supplied from the inverter 44. The drive generated by rotation of the motor 45 is transferred to an axle and driving wheels W via a differential gear unit, for example.

The vehicle 400 also includes a regenerative brake mechanism (regenerator), though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connecting line Li is connected to the negative electrode terminal 414 of the vehicle power source 41. The other terminal of the connecting line Li is connected to a negative electrode input terminal 417 of the inverter 44. A current detector (current detecting circuit) 416 in the battery management unit 411 is provided on the connecting line Li in between the negative electrode terminal 414 and negative electrode input terminal 417.

One terminal of a connecting line L2 is connected to the positive electrode terminal 413 of the vehicle power source 41. The other terminal of the connecting line L2 is connected to a positive electrode input terminal 418 of the inverter 44. The switch unit 415 is provided on the connecting line L2 in between the positive electrode terminal 413 and the positive electrode input terminal 418.

The external terminal 43 is connected to the battery management unit 411. The external terminal 43 is able to connect, for example, to an external power source.

The vehicle ECU 42 performs cooperative control of the vehicle power source 41, switch unit 415, inverter 44, and the like, together with other management units and control units including the battery management unit 411 in response to inputs operated by a driver or the like. Through the cooperative control by the vehicle ECU 42 and the like, output of electric power from the vehicle power source 41, charging of the vehicle power source 41, and the like are controlled, thereby performing the management of the whole vehicle 400. Data concerning the security of the vehicle power source 41, such as a remaining capacity of the vehicle power source 41, are transferred between the battery management unit 411 and the vehicle ECU 42 via communication lines.

The vehicle according to the sixth embodiment is installed with the battery pack according to the fifth embodiment. Thus, by virtue of being equipped with a battery pack with high energy density, the vehicle can exhibit high performance. Moreover, since the storage performance of the battery pack is excellent, the vehicle is highly reliable.

### EXAMPLES

Hereinafter, the above embodiments will be described in more detail based on examples. Identification of crystal phases and estimation of crystal structures for the synthesized monoclinic niobium titanium-containing oxides (niobium titanium-containing oxide phase) and the like were performed according to powder X-ray diffractometry using Cu-Kα ray. The composition of products were analyzed by the ICP method, to confirm that an intended product was obtained.

### Example 1

An active material was produced by the following procedures.

First, a niobium titanium-containing oxide having a monoclinic crystal system and represented by Nb₂TiO₇ was synthesized. The synthesis was carried out according to the method described in the first embodiment, including performing the Na removal treatment.

Next, the obtained oxide powder was made into a composite with a carbon material. More specifically, first, polyvinyl alcohol (PVA) having a saponification degree of 98% as the carbon-containing compound was mixed with pure water, to prepare a 15 mass % aqueous solution of PVA. To the aqueous solution, an oxide powder was mixed and stirred, to prepare a dispersion. The mass ratio between the oxide particle and PVA in the dispersion was found to be 15% by mass. To the dispersion, an aqueous ammonia solution was added to adjust the pH of the dispersion within the range of pH 11.5 to 12.4.

Next, the thus obtained dispersion (in pure water) containing the composite having a phase of PVA before carbonization formed on at least a part of the surface of the oxide particle was subjected to spray drying. The obtained powder was then recovered, dried at 100° C. for 12 hours to thoroughly remove the solvent, and then subjected to carbonization firing in a reductive atmosphere.

First, the powder was preheated for dehydration in a tubular furnace in an atmosphere with nitrogen gas flow, at 500° C. for 30 minutes, and then cooled down to room temperature. The sample was then transferred into a glass tube, the glass tube was evacuated, into which nitrogen gas was then filled and sealed. The carbonization firing was conducted in such nitrogen sealed atmosphere at 500° C. for one hour, during which adhesion of tar-like viscous liquid to the glass tube was confirmed. The carbonization firing was terminated upon cooling down to room temperature, to obtain an active material that contains a carbon coating layer.

Next, the agglomeration of the obtained active material was lightly resolved using a mortar. An active material for evaluation in Example 1 was thus obtained.

For the thus obtained active material, a state of the coated carbon was investigated by TEM observation. First, metal Ru was made to be adsorbed onto the surface of the active material by vapor deposition. The sample powder was then embedded in resin, and processed into a thin sample by ion milling with use of DualMill 600 manufactured by Gatan Inc. A freely selected primary particle of the thus processed sample was subjected to TEM observation. For the TEM apparatus, H-9000UHR III manufactured by Hitachi, Ltd. was used, and evaluation was conducted at an acceleration voltage of 300 kV, and at a 2,000,000 fold image magnification. The active material for evaluation in Example 1 was found to have a thickness of the carbon coating layer of approximately 2.0 nm, with high smoothness and uniformity of coating.

For the active material for evaluation, the BET specific surface area measured by the nitrogen adsorption method was 3.1 m²/g. The coat weight ratio by the carbon coating layer relative to the total mass of the active material, when determined by the aforementioned heating method, was found to be 2.3% by weight. The carboxyl group concentration ([COOH]/Cₜₒₜₐₗ×100%) regarding the active material for evaluation of Example 1 was determined by the aforementioned method. In Example 1, the carboxyl group concentration was found to be 0.06%.

Also the Na content in the niobium titanium-containing oxide phase was determined. In Example 1, the Na content was found to be 50 ppm.

### Examples 2-15

The oxide synthesized as the niobium titanium-containing oxide phase was changed to those of compositions summarized below in Table 2. Further, the conditions for making the composite between the thus obtained oxides and the carbon coating layer were changed to those summarized in Table 3 below. Except for these modifications, active materials for evaluation were obtained in the same manner as in Example 1. The obtained active material for evaluation was analyzed in the same manner as in Example 1. Results of the analysis are summarized in Tables 2 and 3.

### Comparative Example 1

When Niobium titanium-containing oxide Nb₂TiO₇ was synthesized, the Na removal treatment was omitted. Further, the conditions for making the composite between the thus obtained oxide and the carbon coating layer were changed to those summarized in Table 3 below. Except for these modifications, an active material for evaluation was obtained in the same manner as in Example 1. Note that in Comparative Example 1, the preheating in the carbon coating process was omitted. The obtained active material for evaluation was analyzed in the same manner as in Example 1. Results of the analysis are summarized in Tables 2 and 3.

### Comparative Example 2

When Niobium titanium-containing oxide Nb₂TiO₇ was synthesized, the Na removal treatment was omitted. Further, the conditions for making the composite between the thus obtained oxide and the carbon coating layer were changed to those summarized in Table 3 below. Except for these modifications, an active material for evaluation was obtained in the same manner as in Example 1. The obtained active material for evaluation was analyzed in the same manner as in Example 1. Results of the analysis are summarized in Tables 2 and 3.

### Comparative Example 3

The conditions for making the composite between the niobium titanium-containing oxide phase and the carbon coating layer were changed to those summarized in Table 3 below. Except for this, an active material for evaluation was obtained in the same manner as in Example 1. The obtained active material for evaluation was analyzed in the same manner as in Example 1. Results of the analysis are summarized in Tables 2 and 3.

### Comparative Example 4

As the niobium titanium-containing oxide phase, synthesized was a niobium titanium-containing oxide represented by Li₂Na_{1.5}Ti_{5.5}Nb_{0.5}O₁₄ and having an orthorhombic crystal structure belonging to a space group Fmmm, in place of the monoclinic niobium titanium-containing oxide. Note that the Na removal treatment was not performed in the synthesis. Also the conditions for making the composite between the thus obtained oxide and the carbon coating layer were changed to those summarized in Table 3 below. Except for these modifications, an active material for evaluation was obtained in the same manner as in Example 1. The obtained active material for evaluation was analyzed in the same manner as in Example 1. Results of the analysis are summarized in Tables 2 and 3.

### Comparative Example 5

Similarly to Comparative Example 4, orthorhombic Li₂Na_{1.5}Ti_{5.5}Nb_{0.5}O₁₄ was synthesized as the niobium titanium-containing oxide phase, in place of the monoclinic niobium titanium-containing oxide. The Na removal treatment was not performed in Comparative Example 5, either. Further, the conditions for making the composite between the thus obtained oxide and the carbon coating layer were changed to those summarized in Table 3 below. Except for these modifications, an active material for evaluation was obtained in the same manner as in Example 1. The obtained active material for evaluation was analyzed in the same manner as in Example 1. Results of the analysis are summarized in Tables 2 and 3.

Table 2 below summarizes the composition, crystal system, and Na content of the niobium titanium-containing oxide phases obtained in Examples 1 to 15 and Comparative Examples 1 to 5. Moreover, whether or not the Na removal treatment was performed in the syntheses are summarized.

TABLE 2

| | Niobium titanium-containing oxide phase | | | |
|---|---|---|---|---|
| | | | Whether or not | Na |
| | | Crystal | Na removal treatment | content |
| | Composition | system | was performed | (ppm) |
| Example 1 | Nb₂TiO₇ | Monoclinic | Performed | 50 |
| Example 2 | Nb₂TiO₇ | Monoclinic | Performed | 52 |
| Example 3 | Nb₂TiO₇ | Monoclinic | Performed | 38 |
| Example 4 | Nb₂TiO₇ | Monoclinic | Performed | 44 |
| Example 5 | Nb₂TiO₇ | Monoclinic | Performed | 63 |
| Example 6 | Nb₂TiO₇ | Monoclinic | Performed | 48 |
| Example 7 | Nb₂TiO₇ | Monoclinic | Performed | 51 |
| Example 8 | Nb_{1.97}Ta_{0.01}V_{0.01}Y_{0.01}TiO₇ | Monoclinic | Performed | 58 |
| Example 9 | Nb₂Ti_{0.9}Zr_{0.05}Sn_{0.05}O₇ | Monoclinic | Performed | 60 |
| Example 10 | Nb_{1.97}K_{0.03}Ti_{0.93}Mo_{0.04}W_{0.03}O₇ | Monoclinic | Performed | 55 |
| Example 11 | Nb_{1.7}Mo_{0.3}Ti_{0.7}Cr_{0.1}Fe_{0.1}Al_{0.1}O₇ | Monoclinic | Performed | 43 |
| Example 12 | Nb_{1.7}Mo_{0.3}Ti_{0.7}Mn_{0.05}Ni_{0.05}Y_{0.1}Co_{0.1}O₇ | Monoclinic | Performed | 56 |
| Example 13 | Nb₁₀Ti₂O₂₉ | Monoclinic | Performed | 49 |
| Example 14 | Nb₁₄TiO₃₇ | Monoclinic | Performed | 43 |
| Example 15 | Nb₂₄TiO₆₂ | Monoclinic | Performed | 57 |
| Comparative | Nb₂TiO₇ | Monoclinic | Not performed | 105 |
| Example 1 | | | | |
| Comparative | Nb₂TiO₇ | Monoclinic | Not performed | 110 |
| Example 2 | | | | |
| Comparative | Nb₂TiO₇ | Monoclinic | Performed | 39 |
| Example 3 | | | | |
| Comparative | Li₂Na_{1.5}Ti_{5.5}Nb_{0.5}O₁₄ | Orthorhombic | Not performed | 62152 |
| Example 4 | | | | |
| Comparative | Li₂Na_{1.5}Ti_{5.5}Nb_{0.5}O₁₄ | Orthorhombic | Not performed | 62152 |
| Example 5 | | | | |

Table 3 below summarizes conditions for making the composite between the niobium titanium-containing oxide phase and the carbon coating layer, and results of various analyses on the obtained active materials for evaluation in Examples 1 to 15 and Comparative Examples 1 to 5. The conditions for making the composite summarized herein include the saponification degree of PVA used for carbon coating treatment, preheating conditions, and carbonization conditions. Results of analyses summarized herein include carboxyl group concentration, carbon-coat weight ratio, thickness of carbon coating layer, and BET specific surface area.

TABLE 3

| | | | | | | | Active |
|---|---|---|---|---|---|---|---|
| | Conditions for making composite | | | Formed carbon coating layer | | | material |
| | with carbon coating layer | | | Carboxyl | Carbon-coat | | particle |
| | | Preheating | Carbonization | group | weight | | BET specific |
| | Saponification | conditions | conditions | concentration | ratio | Thickness | surface area |
| | degree | Temp. Time | Temp. Time | (%) | (wt %) | (nm) | (m²/g) |
| Example 1 | 98 | 500° C., 30 m | 500° C., 1 h | 0.06 | 1.7 | 2.0 | 3.3 |
| Example 2 | 80 | 500° C., 30 m | 500° C., 1 h | 1.68 | 2.1 | 2.2 | 3.2 |
| Example 3 | 75 | 500° C., 30 m | 500° C., 1 h | 2.55 | 2.4 | 3.1 | 5.2 |
| Example 4 | 70 | 500° C., 30 m | 500° C., 1 h | 4.91 | 3.8 | 3.8 | 8.3 |
| Example 5 | 70 | 500° C., 30 m | 550° C., 1 h | 3.89 | 3.2 | 3.5 | 6.9 |
| Example 6 | 70 | 500° C., 30 m | 600° C., 1 h | 2.37 | 2.4 | 2.7 | 4.8 |
| Example 7 | 70 | 500° C., 30 m | 700° C., 1 h | 0.63 | 1.9 | 2.2 | 3.2 |
| Example 8 | 70 | 500° C., 30 m | 600° C., 1 h | 2.38 | 2.3 | 2.6 | 4.5 |
| Example 9 | 70 | 500° C., 30 m | 600° C., 1 h | 2.39 | 2.4 | 2.5 | 4.6 |
| Example 10 | 70 | 500° C., 30 m | 600° C., 1 h | 2.37 | 2.4 | 2.5 | 4.5 |
| Example 11 | 70 | 500° C., 30 m | 600° C., 1 h | 2.39 | 2.3 | 2.6 | 4.5 |
| Example 12 | 70 | 500° C., 30 m | 600° C., 1 h | 2.41 | 2.4 | 2.7 | 4.6 |
| Example 13 | 70 | 500° C., 30 m | 600° C., 1 h | 2.39 | 2.4 | 2.6 | 4.5 |
| Example 14 | 70 | 500° C., 30 m | 600° C., 1 h | 2.42 | 2.4 | 2.6 | 4.5 |
| Example 15 | 70 | 500° C., 30 m | 600° C., 1 h | 2.38 | 2.3 | 2.5 | 4.6 |
| Comparative | 70 | (None) | 700° C., 1 h | 0.59 | 1.9 | 2.3 | 3.3 |
| Example 1 | | | | | | | |
| Comparative | 70 | 500° C., 30 m | 700° C., 1 h | 0.53 | 1.9 | 2.2 | 3.2 |
| Example 2 | | | | | | | |
| Comparative | 95 | 500° C., 30 m | 700° C., 2 h | 0 | 1.8 | 2.0 | 3.4 |
| Example 3 | | | | | | | |
| Comparative | 70 | 500° C., 30 m | 600° C., 1 h | 2.38 | 2.2 | 2.5 | 4.4 |
| Example 4 | | | | | | | |
| Comparative | 95 | (None) | 700° C., 1 h | 0 | 2.2 | 2.7 | 2.9 |
| Example 5 | | | | | | | |

Next, the active materials for evaluation obtained in Examples 1 to 15 and Comparative Examples 1 to 5 were evaluated regarding the storage performance of battery, as follows.

A nonaqueous electrolyte battery was manufactured by the following procedures.

(Fabrication of Negative Electrode)

Negative electrodes were fabricated as described below. Particles (carbon-coated particles) of the active materials obtained in Examples 1 to 15 and Comparative Examples 1 to 5 were used as the negative electrode active material.

First, each negative electrode active material was milled so as to have an average particle size of 5 μm or smaller, to obtain a milled product. Next, 6 parts by mass of acetylene black as an electro-conductive agent was mixed, relative to 100 parts by mass of the negative electrode active material. Next, 4 parts by mass of a low-cost carbon fiber, more specifically, a carbon nanotube containing 852 ppm by mass of cobalt atoms as impurity, was added as another electro-conductive agent, relative to 100 parts by mass of the negative electrode active material, to obtain a mixture. Next, the mixture was dispersed in NMP (N-methyl-2-pyrrolidone), to obtain a dispersion. Polyvinylidene fluoride (PVdF) as a binder was mixed into the dispersion at a proportion of 10 parts by mass relative to 100 parts by mass of the negative electrode active material, to prepare a negative electrode slurry. The slurry was coated onto a current collector made of an aluminum foil, using a blade. The product was dried at 130° C. for 12 hours under vacuum, and then rolled so as to adjust the density of the active material-containing layer (excluding the current collector) to 2.2 g/cm³, to obtain a negative electrode.

(Fabrication of Positive Electrode)

Positive electrodes were fabricated as follows. Lithium nickel manganese cobalt composite oxide (LiNi_{1/3}Mn_{1/3}Co_{1/3}O₂) was used as a positive electrode active material.

First, to 100 parts by mass of the positive electrode active material, 5 parts by mass of acetylene black as an electro-conductive agent was mixed to obtain a mixture. Next, the mixture was dispersed in NMP, to obtain a dispersion. PVdF as a binder was mixed to the dispersion at a proportion of 5 parts by mass relative to the positive electrode active material, to prepare a positive electrode slurry. The slurry was coated onto a current collector made of an aluminum foil, using a blade. The product was dried at 130° C. for 12 hours under vacuum, and then rolled so as to adjust the density of the active material-containing layer (excluding the current collector) to 2.1 g/cm³, to obtain a positive electrode.

(Fabrication of Electrode Group)

The thus fabricated positive electrode and negative electrode were stacked, with a polyethylene separator interposed therebetween, to obtain a stack. The stack was then wound up and further pressed, to obtain a flat-shaped wound electrode group. A positive electrode terminal and a negative electrode terminal were connected to the electrode group.

(Preparation of Nonaqueous Electrolyte)

A mixed solvent of ethylene carbonate and diethyl carbonate (volume ratio=1:1) was prepared. Lithium hexafluorophosphate (LiPF₆) was then dissolved in the solvent, at concentration of 1 M. A nonaqueous electrolyte was thus prepared.

(Assembly of Nonaqueous Electrolyte Battery)

A nonaqueous electrolyte battery was fabricated using the thus fabricated electrode group and the nonaqueous electrolyte.

(Storage Test)

Each of the obtained nonaqueous electrolyte batteries was subjected to a storage test at room temperature. In the storage test, first, each battery was charged and discharged twice, within a battery voltage range of 1.5 V to 3.0 V at a current value of 0.2 C (hourly discharge rate). Next, the battery was charged at a constant current at a charge current value of 0.2 C (hourly discharge rate) until the battery voltage reached 3.0 V, and further charged at constant voltage until the charge current converged to 1/20 C, thereby achieving full charge. The battery was stored in a thermostatic bath at 25° C., and change in open circuit voltage was investigated. Taking the open circuit voltage 12 hours after the full charge as V₁, and the open circuit voltage on the 30th day as V₃₀, the daily voltage drop rate (mV/Day) was determined by (V₁− V₃₀)/30 days. The results are summarized in Table 4 below.

Moreover, the adsorption rate of metal ions adsorbed during the storage by the carboxyl groups of the carbon coating layer included in the negative electrode active material was examined as follows. First, the negative electrode was taken out by disassembling the battery, washed, then immersed in water so as to quench the active material-containing layer, and thereafter, the negative electrode active material was extracted. The thus extracted active material was subjected to XPS measurement and C1s peak fitting to acquire quantitative result, from which COO component concentration [COO] was determined. Next, the carboxyl group was selectively quantified by chemical modification with trifluoroethanol, to acquire the amount of carboxyl group [COOH]. Next, the presence or absence of any metal carboxylate group, such as COOCo (cobalt carboxylate group), was examined by time-of-flight secondary ion mass spectrometry (TOF-SIMS), and if present, the amount of COO components other than carboxyl groups ([COO]−[COOH]) was calculated as the content of metal carboxylate group [COOMe]. The adsorption rate of metal ions was determined by calculating the amount of metal carboxylate salt [COOMe], relative to the concentration of total COO component [COO] determined before chemical modification with trifluoroethanol as a percentage ([COOMe]/[COO]×100%). The results are summarized in Table 4.

TABLE 4

Results of storage test

| | Voltage drop | Metal ion |
|---|---|---|
| Negative electrode | rate | adsorption rate |
| active material | (mV/day) | (%) |
| Example 1 | 1.15 | 100 |
| Example 2 | 0.85 | 98.3 |
| Example 3 | 0.24 | 83.1 |
| Example 4 | 0.15 | 43.5 |
| Example 5 | 0.18 | 52.1 |
| Example 6 | 0.21 | 78.6 |
| Example 7 | 0.95 | 100 |
| Example 8 | 0.19 | 81.8 |
| Example 9 | 0.22 | 80.9 |
| Example 10 | 0.21 | 81.2 |
| Example 11 | 0.23 | 82.4 |
| Example 12 | 0.18 | 83.3 |
| Example 13 | 0.20 | 81.7 |
| Example 14 | 0.21 | 83.6 |
| Example 15 | 0.25 | 82.5 |
| Comparative | 2.85 | 100 |
| Example 1 | | |
| Comparative | 3.32 | 100 |
| Example 2 | | |
| Comparative | 2.98 | 0 |
| Example 3 | | |
| Comparative | 2.62 | 100 |
| Example 4 | | |
| Comparative | 2.58 | 0 |
| Example 5 | | |

As summarized in Table 4, with the batteries using the active materials for evaluation in Examples 1 to 15 for the negative electrodes, the daily voltage drop rate during the storage test had been limited to 1.15 mV or less. These batteries, using negative electrode active materials in which the monoclinic niobium titanium-containing oxide phase having a Na content of 100 ppm or less were coated with the carbon coating layer having a carboxyl group content of 0.001% or more, were found to successfully suppress self-discharge, despite a low-grade carbon nanotube that contains cobalt impurity was contained in the electro-conductive agent. In particular, the batteries using the active materials in Examples 3 to 6 and 8 to 15 were found to limit the daily voltage drop rate to 0.25 mV or less. As can be seen from the adsorption rate of metal ions being limited to 84% or less during the storage test, these Examples had plentiful capacity for adsorbing the metal ions like the impurity cobalt atoms and metal eluted from the positive electrode, by virtue of having the carboxyl group content in the carbon coating layer of 2.3% or more.

In contrast, for the batteries using the active materials for evaluation in Comparative Examples 1 to 5 for the negative electrodes, the daily voltage drop rate during the storage test had exceeded 2.5 mV.

For Comparative Examples 1 and 2, on one hand, the carboxyl group-containing carbon coating layer equivalent to that in Example 7 was obtained, as indicated in Table 3. On the other hand, the niobium titanium-containing oxide phases in these Comparative Examples were found to have high Na content, despite containing the monoclinic Nb₂TiO₇ as summarized in Table 2, since they were synthesized without the Na removal treatment. Hence, Na ions derived from the oxide phase of the active material unfortunately adsorbed onto the carboxyl group of the carbon coating layer, thus making the carbon coating layer unable to demonstrate the performance of adsorbing the metal ions such as cobalt in the battery, so that the self-discharge could not be suppressed.

In Comparative Examples 3 and 5, upon coating the carbon coating layer onto the niobium titanium-containing oxide phase, the carboxyl groups had become carbonized and did not remain. This led the battery to cause self-discharge, due to deposition of metal ions such as cobalt. Note that the amounts of adsorption of metal ions for these Comparative Examples are denoted as 0% in Table 4, since no carboxyl group was contained in the carbon coating layers.

Comparative Example 4 was found to have a remarkably large Na content, since the Na-rich orthorhombic niobium titanium composite oxide Li₂Na_{1.5}Ti_{5.5}Nb_{0.5}O₁₄ was used for the niobium titanium-containing oxide phase. Hence, Na ions derived from the oxide phase of the active material had adsorbed onto the carboxyl group of the carbon coating layer, thereby making the carbon coating layer unable to demonstrate the performance of adsorbing the metal ions such as cobalt in the battery, so that self-discharge could not be suppressed. As can be seen in Table 4, between the battery using the active material in Comparative Example 4, and the battery using the active material in Comparative Example 5, for which Li₂Na_{1.5}Ti_{5.5}Nb_{0.5}O₁₄ was used similarly to Comparative Example 4 but had no carboxyl group remaining, the levels of self-discharge were of the same degree. In this manner, when orthorhombic Na-containing titanium composite oxide is used as the main active material, as a consequence of the severely large Na content, use of a fibrous carbon containing impurities such as Co would result in failure of suppressing the self-discharge, irrespective of presence or absence of carboxyl group in the coating layer. Note that, as a matter of course, performing the Na removal treatment on the orthorhombic Na-containing titanium composite oxide such as Li₂Na_{1.5}Ti_{5.5}Nb_{0.5}O₁₄, which contains a large amount and not a trace amount of Na as a constituent element, would be utter nonsense.

The active material according to at least one embodiment and example described above includes a niobium titanium-containing oxide phase including niobium titanium-containing oxide having a monoclinic structure and 0 ppm or more and 100 ppm or less of Na, and a carbon coating layer covering at least a part thereof and containing 0.001% or more carboxyl groups. The active material can realize a secondary battery that can exhibit high energy density and is excellent in storage performance, a battery pack including the secondary battery, and a vehicle having the battery pack installed thereon.

The present disclosure also encompasses the following embodiments of active materials, electrodes, secondary batteries, and the like:
1. An active material comprising:
a niobium titanium-containing oxide phase that comprises a niobium titanium-containing oxide having a monoclinic structure and Na, a Na content in the niobium titanium-containing oxide phase being 0 ppm or more and 100 ppm or less; and
a carbon coating layer that coats at least a part of the niobium titanium-containing oxide phase, the carbon coating layer containing 0.001% or more of carboxyl group.
2. The active material according to clause 1, wherein the niobium titanium-containing oxide phase contains a crystal structure of at least one phase selected from a group consisting of Nb₂TiO₇ phase, Nb₁₀Ti₂O₂₉ phase, Nb₁₄TiO₃₇ phase, and Nb₂₄TiO₆₄ phase.
3. The active material according to clause 2, wherein the at least one phase contains at least one element selected from a group consisting of K, Zr, Sn, V, Nb, Ta, Mo, W, Y, Fe, Co, Cr, Mn, Ni, and Al.
4. The active material according to any one of clauses 1 to 3, containing an active material particle having a BET specific surface area of 0.8 m²/g or greater and less than 50 m²/g.
5. An electrode comprising the active material according to any one of clauses 1 to 4.
6. The electrode according to clause 5, comprising an active material-containing layer, the active material-containing layer containing the active material and an electro-conductive agent that contains a fibrous carbon.
7. A secondary battery comprising:
a positive electrode;
a negative electrode; and an electrolyte,
the negative electrode comprising the electrode according to clause 5 or 6.
8. The secondary battery according to clause 7, wherein the positive electrode comprises a positive electrode active material, and the positive electrode active material comprises a lithium phosphate having an olivine structure.
9. The secondary battery according to clause 7 or 8, wherein the positive electrode comprises a positive electrode active material, and the positive electrode active material comprises at least one selected from a group consisting of lithium manganese composite oxide having a spinel structure, lithium cobalt composite oxide, lithium nickel cobalt composite oxide, lithium manganese cobalt composite oxide, and lithium nickel cobalt manganese composite oxide.
10. A battery pack comprising the secondary battery according to any one of clauses 7 to 9.
11. The battery pack according to clause 10, further comprising:
an external power distribution terminal; and
a protective circuit.

12. The battery pack according to clause 10 or 11, further comprising plural of the secondary battery, the secondary batteries being electrically connected in series, in parallel, or in a combination of in series and in parallel.
13. A vehicle comprising the battery pack according to any one of clause 10 to 12.
14. The vehicle according to clause 13, comprising a mechanism that converts kinetic energy of the vehicle into regenerative energy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An active material comprising:
a niobium titanium-containing oxide phase that comprises a niobium titanium-containing oxide having a monoclinic structure and Na, a Na content in the niobium titanium-containing oxide phase being 0 ppm or more and 100 ppm or less; and
a carbon coating layer that coats at least a part of the niobium titanium-containing oxide phase, the carbon coating layer containing 0.001% or more of carboxyl group.

2. The active material according to claim 1, wherein the niobium titanium-containing oxide phase contains a crystal structure of at least one phase selected from a group consisting of Nb₂TiO₇ phase, Nb₁₀Ti₂O₂₉ phase, Nb₁₄TiO₃₇ phase, and Nb₂₄TiO₆₄ phase.

3. The active material according to claim 2, wherein the at least one phase contains at least one selected from a group consisting of K, Zr, Sn, V, Nb, Ta, Mo, W, Y, Fe, Co, Cr, Mn, Ni, and Al.

4. The active material according to claim 1, containing an active material particle having a BET specific surface area of 0.8 m²/g or greater and less than 50 m²/g.

5. An electrode comprising the active material according to claim 1.

6. The electrode according to claim 5, comprising an active material-containing layer, the active material-containing layer containing the active material and an electro-conductive agent that contains a fibrous carbon.

7. A secondary battery comprising:
a positive electrode;
a negative electrode; and
an electrolyte,
the negative electrode comprising the electrode according to claim 5.

8. The secondary battery according to claim 7, wherein the positive electrode comprises a positive electrode active material, and the positive electrode active material comprises a lithium phosphate having an olivine structure.

9. The secondary battery according to claim 7, wherein the positive electrode comprises a positive electrode active material, and the positive electrode active material comprises at least one selected from a group consisting of lithium manganese composite oxide having a spinel structure, lithium cobalt composite oxide, lithium nickel cobalt composite oxide, lithium manganese cobalt composite oxide, and lithium nickel cobalt manganese composite oxide.

10. A battery pack comprising the secondary battery according to claim 7.

11. The battery pack according to claim 10, further comprising:
an external power distribution terminal; and
a protective circuit.

12. The battery pack according to claim 10, further comprising plural of the secondary battery, the secondary batteries being electrically connected in series, in parallel, or in a combination of in series and in parallel.

13. A vehicle comprising the battery pack according to claim 10.

14. The vehicle according to claim 13, comprising a mechanism that converts kinetic energy of the vehicle into regenerative energy.
